(19) United States
(12) Patent Application Publication
(10) Pub. No.: US 2026/0309277 A1
(43) Pub. Date: Oct. 8, 2026

(54) A HYDROGEN REFUELING SYSTEM

(71) Applicant: Cavendish Hydrogen A/S, Herning (DK)

(72) Inventors: Sascha DORNER, Gramatneusiedl (AT); Michael STEFAN, Eggendorf (AT)

(21) Appl. No.: 19/481,704

(22) PCT Filed: May 14, 2024
(86) PCT No.: PCT/DK2024/050110

§ 371 Date: Nov. 5, 2025

(30) Foreign Application Priority Data
May 16, 2023 (DK) PA 2023 70236

(51) Int. Cl. F17C 5/00; F17C 5/06; F17C 13/02

(52) U.S. Cl. CPC F17C 5/007; F17C 5/06; F17C 13/025; F17C 2221/012; F17C 2223/0123; F17C 2223/036; F17C 2225/0123; F17C 2225/036; F17C 2227/0157; F17C 2227/0185; F17C 2250/032; F17C 2250/043; F17C 2250/0439; F17C 2250/0636; F17C 2250/0689; F17C 2260/025; F17C 2270/0139

(57) ABSTRACT

The invention relates to a hydrogen refueling system (HRS) comprising: a mobile gas supply (MGS) comprising two or more mobile gas supply vessels (GSV1-GSV2); a hydrogen refueling station comprising: a common outlet connectable to a receiving vessel; a compression arrangement including compression stages connected to said common outlet (CO), wherein at least one compression stage (CS1) is configured to establish an outlet pressure substantially equal to an inlet pressure of a second compression stage (CS2); a supply conduit arrangement (SCA) comprising supply conduits (SC1,SC2) each comprising a supply valve (SV1,SV2), and wherein each supply conduit are separately connected to a respective mobile gas supply vessel and to a respective compression stage; one or more controllers (CTR) controlling said compression stages and supply valves to establish a gas supply flow from said mobile gas supply to said receiving vessel (RV) via each respective supply conduits, said compression arrangement and said common outlet,

### FIELD OF THE INVENTION

The present invention relates to a hydrogen refueling system, to a method of filling a receiving vessel and to a hydrogen refueling station.

### BACKGROUND OF THE INVENTION

Demand for gas including hydrogen is increasing, in turn increasing the demand for supply to the refueling stations, including hydrogen refueling stations. However, traditional ways of filling vessels, such as storage vessels of a refueling station, from a supply vessel, is limited in the sense that increasing the rate at which the supply vessel is emptied may result in a critical temperature drop that could damage the station and/or the supply vessel. To avoid reaching critically low temperatures, it may thus take long time to empty a supply vessel, hence, making it difficult keep up with supply demands.

### SUMMARY OF THE INVENTION

The inventors have identified the above-mentioned problems and challenges related to refueling systems, and subsequently made the below-described invention, which may, e.g., increase the filling rate, e.g., the rate at which a vessel is filled from a supply and/or the rate at which a supply is emptied or similarly, reduce the time it takes to fill a vessel from a supply.

The invention relates to a hydrogen refueling system comprising: a mobile gas supply comprising two or more mobile gas supply vessels; a hydrogen refueling station comprising: a common outlet fluidly connectable to a receiving vessel; a compression arrangement including two or more compression stages each having an inlet and an outlet; and wherein said two or more compression stages are fluidly connected to said common outlet, and wherein at least one compression stage of said two or more compression stages is configured to establish an outlet pressure substantially at least equal to an inlet pressure of a second compression stage of said two or more compression stages; a supply conduit arrangement comprising two or more supply conduits each comprising a supply valve and each having an upstream end and a downstream end, and wherein each said upstream end is separately fluidly connected to a respective mobile gas supply vessel of said two or more mobile gas supply vessels, and wherein each said downstream end is separately fluidly connected to a respective compression stage of said two or more compression stages; one or more controllers configured to control said two or more compression stages and said supply valves to establish a gas supply flow from said mobile gas supply to said receiving vessel via each respective supply conduits of said two or more supply conduits, said compression arrangement and said common outlet, when said receiving vessel is fluidly connected to said common outlet.

Advantageously, the invention provides the capability of filling of a receiving vessel with gas transferred simultaneously from two or more mobile gas supply vessels, when the receiving vessel is connected to the hydrogen refueling station. Advantageously, this may enable faster filling of the receiving vessel, while at the same time avoiding reaching critically low temperatures. Of further advantage, the filling of the receiving vessel can be continued during swapping of, e.g., an empty mobile gas supply vessel with another mobile gas supply vessel comprising gas with no substantial intermittent stoppage caused by an empty mobile gas supply vessel, which is advantageous.

Advantageously, this may enable use of supply conduits having a smaller cross section, which advantageously require less material for the supply conduits.

The term receiving vessel may refer to a storage vessel, to a mobile storage vessel and to a vessel of vehicle. The storage vessel may be a stationary storage vessel, which may or may not be including as a storage of the hydrogen refueling station. The vessel of a vehicle may be a vessel of vehicle such as a hydrogen vehicle, wherein the vehicle may be of various types including light duty as well as heavy duty vehicles. Non-limiting examples of such light duty and heavy-duty vehicles may, e.g., comprise cars, trucks, ships, airplanes, trains and drones.

The term fluidly connected may refer to components being connected via conduits configured to comprise a fluid such as a gas. Hence, the fluidly connected means that fluid may be transferred via the connection. The fluid connection is typically comprised of conduits (pipes or pipelines) configured for containing and transferring fluids.

The term mobile gas supply vessel may refer to a mobile gas storage comprising one or more storage vessels configured to contain gas. The mobile gas supply vessel may be mobile in the sense that it is configured to be moved from one location to another using a vehicle, which may be a boat, a truck, a train, a plane etc. A non-limiting example of a mobile gas supply vessel could be a trailer comprising one or more storage vessels. The term mobile gas supply vessel may sometimes also be referred to as portable. A portable gas supply may be transferred between locations in various ways. E.g., the term mobile and portable may refer to, e.g., a trailer such as a trailer complying with standard defined requirements for a MEGC trailer or a battery vehicle. Such trailer comprising one or more gas supply vessels, and the trailer being portable in the sense that it may have wheels and may thereby be moved between locations using, e.g., different types of vehicles, including a truck.

The term compression arrangement refers to an arrangement comprising compression stages configured to compress gas. The term compression stage may in a broad sense refer to various arrangements configured to compress gas. Thus, the term may refer to one or more compression stages of a compressor including, e.g., a multistage compressor. However, the term may also be understood to comprise a single compressor. Hence, two or more compression stage may be understood as referring to two individual compressors, or it may be understood as referring to two or more compression stages of, e.g., a multistage compressor. Moreover, it should be understood that one of the two or more compression stages may be a stage of a multistage compressor or it may be a single stage compressor, and that another compression stage of the two or more compression stages may be a multistage compressor or a single stage compressor. Hence, it should be understood that the combined use of a multistage compressor and a single stage compressor is encompassed by the term two or more compression stages. The two compression stages may thus be substantially identical or different to one another.

When referring to a pressure of a vessel, of a conduit or of another component configured to contain gas, it should be understood that the pressure relates to the pressure of the gas contained inside the component.

The term common outlet may be understood as an outlet, which may be a conduit. A compression stage may be connected to the common outlet directly or it may be connected to the common outlet via other components such as, e.g., other compression stages and conduits.

According to an embodiment of the invention, said gas is hydrogen.

Advantageously, this has the effect of enabling refilling of a receiving vessel of the hydrogen refueling station with hydrogen from two mobile gas supply vessels.

According to an embodiment of the invention, said establish a gas supply flow from said mobile gas supply to said receiving vessel comprises a controller of said one or more controllers controlling each of said supply valves between a closed state and an open state.

Advantageously, this may have the effect of establishing a fluid path from each mobile gas supply vessels to each compression stage when the supply valve(s) are open, or terminating the fluid path when the valve(s) are closed. One valve may be opened while another valve is closed to establish a gas flow in one of the supply conduits while the terminating a gas flow in one or more other supply conduits, which is advantageous. When tow supply valves are in an open state, a simultaneous gas flow from the two or more mobile gas supply vessels may flow in parallel to separate compression stages via two separate supply conduits, thereby enabling filling of a receiving vessel from two or more mobile gas supply vessels, which is advantageous. Also, advantageously a supply valve may be closed during a decoupling of a mobile gas supply vessel to terminate the gas flow from that mobile gas supply vessel.

According to an embodiment of the invention, said receiving vessel is a storage vessel and wherein said storage vessel is included in said hydrogen refueling station.

Advantageously, this may have the effect that the hydrogen refueling station may store gas received from the mobile gas supply. Further advantageous, the storage vessel may be filled with gas from two or more mobile gas supply vessels simultaneously, hence, reducing the time required to fill the storage vessel.

According to an embodiment of the invention, said hydrogen refueling system comprises two or more receiving storage vessels fluidly connected to said common outlet.

Advantageously, this may have the effect of providing a storage vessel that can receive gas from the mobile gas supply vessels, e.g., when the capacity of the other storage vessel and/or another receiving vessel is exceeded. Furthermore, having two or more storage vessels may advantageously enable filling of one storage vessel, while the other storage vessel of the hydrogen refueling station may simultaneously be utilized for refueling a vehicle. E.g. refueling a vehicle via a dispensing module of the hydrogen refueling station.

According to an embodiment of the invention, said hydrogen refueling station comprises a dispensing module fluidly connected to said common outlet, and wherein said dispensing module comprises a dispenser connectable to a receiving vessel of a vehicle.

Advantageously, this may have the effect of providing refueling of a vehicle with the hydrogen refueling station. Moreover, this may advantageously enable refueling of a vehicle from said two mobile gas supply vessels providing a parallel flow of gas to the vehicle.

It should be understood that the dispensing module may be connected to the common outlet via a station module. The station module may advantageously comprise, e.g., one or more compressors configured to provide pressurized gas received from the common outlet to the vehicle, e.g., to the receiving vessel of the vehicle, which is advantageous. In optional embodiments of the invention, the dispensing module may also be fluidly connected to one or more storage tanks, which is advantageous.

According to an embodiment of the invention, a controller of said one or more controllers is configured to control said gas supply flow in each respective supply conduit of said two or more supply conduits such that a flow rate of said gas supply flow in each respective supply conduit of said two or more supply conduits is different from one another.

Advantageously, this has the effect that the mobile gas supply vessels are emptied at different rates, and hence, when one mobile gas supply vessel has been emptied, the other mobile gas supply vessel may still be providing gas to the receiving vessel, while, e.g., the emptied mobile gas supply vessel is replaced by another mobile gas supply vessel. Furthermore, a lower flow rate in one supply vessel compared to another supply vessel may, advantageously, keep the temperature within the operating range of the components of the hydrogen refueling station and the mobile gas supply vessels by minimizing the pressure drop and the related temperature drop. In this regard, notice that fast emptying at a high flow rate could cause the temperature to drop below a component operation range and the emptying of the mobile gas supply vessel may thus have to be halted.

According to an embodiment of the invention, a controller of said one or more controllers is configured to control said gas supply flow in each supply conduit of said two or more supply conduits based on one or more supply parameters associated with said a gas supply flow in at least one of said supply conduits.

Advantageously, this may have the effect that the gas supply flow may be regulated according to one or more supply parameters. E.g., this may enable a controller to regulate the gas supply flow individually in each supply conduit according to, e.g., changes in one or more supply parameters, which is advantageous.

It should be understood that the controller is able to control the supply flow in each supply conduit independently. Hence, a flow in one supply conduit may be larger than a flow in another supply conduit.

The term control said gas supply flow should be understood as the controller being able to regulate the gas supply flow, e.g., by increasing or decreasing the gas supply flow. The controller may control the flow in various ways, including by controlling flow regulating components of the hydrogen refueling system, such as, e.g., valves, compression stages etc.

According to an embodiment of the invention, said one or more supply parameters include one or more of the list comprising: a state of charge of a mobile gas supply fluidly connected to said supply conduit, a supply pressure of said supply conduit, a supply temperature of said supply conduit, a gas supply flow in said supply conduit.

Advantageously, this may have the effect that the gas supply flow may be regulated according to various parameters related to mobile gas supply and to the supply conduit arrangement, and hence the gas supply flow may be adapted to changes in various parameters. E.g., it may be advantageous to control the gas supply flow in individual supply conduits according to the state of charge of a mobile gas supply connected to that supply conduit. Moreover, it may be advantageous to control the individual gas supply flow according to supply temperature, supply pressure etc., e.g., to ensure that the emptying of the mobile gas supply is performed in such a way that it complies with regulations and safety limits.

According to an embodiment of the invention, said control said gas supply flow in each supply conduit comprises establishing a first gas supply flow in a first supply conduit of said two or more supply conduits according to a first gas supply flow target and establishing a second gas supply flow in a second gas supply conduit of said two or more supply conduits according to a second gas supply flow target.

Advantageously, this may have the effect that it enables the refueling system to establish specific gas supply flows in each individual supply conduits based on the first and second supply flow targets. Thereby, when the first and the second gas supply flow targets are different, the refueling system controls a gas supply in to respective supply vessels to be different, and hence each respective mobile gas supply vessel connected to these supply conduits will be emptied at different rates.

The first target flow rate and the second target flow rate specify two flow rates. However, optionally other parameters such as supply parameters may be included. E.g. a target supply pressure may be specified, to enable control of the gas supply flow according to a target supply pressure.

According to an embodiment of the invention, said first gas supply flow target and said second gas supply flow target is different.

Advantageously, this may enable emptying of two mobile gas supply vessels of the hydrogen refueling system to be emptied at different flow rates. Notice, that this may be carried out even if the two mobile gas supply vessels have similar pressures, similar temperature, and similar state of charge etc., which is advantageous.

According to an embodiment of the invention, said second gas supply flow target is substantially between 10 percent to 60 percent of said first gas supply flow target, such as between 15 percent to 50 percent of said first gas supply flow target, such as between 24 percent to 45 percent of said first gas supply flow target.

According to an embodiment of the invention, said control said gas supply flow comprises establishing a first flow reduction in said gas supply flow in a supply conduit of said two or more supply conduits when a first supply parameter of said one or more supply parameters associated with said supply conduit crosses a first supply parameter threshold.

Advantageously, this may enable the refueling system to perform a flow reduction of the gas supply flow, when a first supply parameter crosses a first supply parameter threshold. E.g., in some situations, reducing the gas supply flow may affect the first supply parameter in such a way that the first supply parameter is moved further away from the first supply parameter threshold. Thereby, the refueling system may be able to respond according to a first supply parameter crossing a first supply parameters threshold, and thereby, the flow may be reduced in time to, e.g., avoid a complete termination of the gas supply flow, which is advantageous, since the filling of the receiving vessel may be continued instead of being completely halted.

The term crossing may refer to a value or parameter falling below a threshold or to a value or parameter exceeding a threshold.

According to an embodiment of the invention, said first flow reduction corresponds substantially to a difference between a first gas supply flow target and a second gas supply flow target.

Advantageously, this may have the effect that the total gas flow to, e.g., the receiving vessel may be substantially maintained.

According to an embodiment of the invention, said first supply parameter threshold is a first supply pressure threshold and wherein said first supply parameter is a supply pressure, and wherein said first flow reduction is performed when said supply pressure crosses said first supply pressure threshold.

Advantageously, the flow reduction may have the effect that the temperature drop is reduced. Hence, the emptying of the vessel may be continued, which is advantageous.

Notice that the supply pressure typically corresponds substantially to the pressure in the mobile gas supply vessel connected to the supply vessel wherein the supply pressure may be measured. However, further notice that the supply pressure may also be measured in the mobile gas supply vessel, according to implementations of the invention.

It should be understood that in the present context the term crosses said first supply threshold may refer to both the supply pressure going above the supply pressure threshold and to the supply pressure going below the supply pressure threshold. However, in preferred implementations of the invention, the flow reduction may be performed when the supply pressure crosses the supply pressure threshold such that the supply pressure is below the supply pressure threshold.

According to an embodiment of the invention, each of said supply conduits of said two or more supply conduits comprises one or more supply parameter sensors configured to measure one or more supply parameters of said supply conduit.

According to an embodiment of the invention, said one or more supply parameter sensors comprises at least a pressure sensor configured to measure a supply pressure of said supply conduit.

Advantageously, this may have the effect that it is possible to monitor a pressuring in said supply conduits. The supply pressure may depend on the pressure in the mobile gas supply vessel connected to the supply conduit and hence, by measuring the supply pressure in said supply conduit using a pressure sensor, it is possible to obtain a representation of the pressure in the mobile gas supply vessel, which is advantageous. Furthermore, by measuring the supply pressure, it may be possible to control a gas supply flow in the supply vessels based on the measured supply pressure.

According to an embodiment of the invention, a controller of said one or more controllers is configured to control said gas supply flow in said each respective supply conduit of said two or more supply conduits based on a supply pressure of each of said respective supply conduits.

Advantageously, this may have the effect of enabling monitoring and control of gas supply flow based on supply pressure in each of said respective supply conduits.

The term supply pressure may in the present context be understood as a pressure representing a pressure in a mobile gas supply vessel connected to the supply conduit. The pressure may be measured on the mobile gas supply vessel, however, the supply pressure may also be measured in a supply conduit connected to the mobile gas supply vessel.

According to an embodiment of the invention, said control said gas supply flow comprises controlling said gas supply flow in each said respective supply conduit such that a mobile gas supply vessel of said two or more mobile gas supply vessels associated with the highest supply pressure of said two or more gas supply vessels are emptied at a higher flow rate compared to another gas supply vessel of said two or more gas supply vessels.

Advantageously, this may have the effect of providing more efficient filling of the receiving vessel from two or more mobile gas supply vessels. E.g., this may exploit that the potential energy in the mobile gas supply vessel associated with the highest pressure is higher than the potential energy of the other mobile gas supply vessel(s), and thereby this may provide a more efficient filling of the receiving vessel based on a parallel flow from two mobile gas supply vessels.

According to an embodiment of the invention, said control said gas supply flow in said each respective supply conduit of said two or more supply conduits comprises establishing a first flow reduction in said gas supply flow in a supply conduit of said two or more supply conduits when a supply pressure associated with said supply conduit crosses a first supply pressure threshold.

Advantageously, this may have the effect of reducing the temperature drop associated with the pressure drop that occur when emptying of the mobile gas supply vessel connected to the supply conduit. Thereby, the emptying of the mobile gas supply vessel connected to the supply conduit may be continued without reaching a critical temperature threshold at which the emptying would need to be discontinued, which is advantageous. Furthermore, this may also reduce energy consumption of the compression stage(s) since the compression stage(s) may not be required to keep providing the same flow rate as the inlet pressure reduces below the supply pressure threshold.

According to an embodiment of the invention, said first flow reduction in said gas supply flow is within the range of a 40 percent to 80 percent reduction, such as within the range of a 50 percent to 70 percent reduction, such as within the range of a 60 percent to 66 percent reduction.

Advantageously, operating the refueling system according to these ranges may have the effect of providing the mentioned efficient filling of the receiving vessels while avoiding reaching temperatures that are so low that the filling of the receiving vessel must be terminated. Also, operating withing these ranges of the first flow reduction may have the effect that the peak power draw of the compression stages is reduced, and thereby a more even power draw over time is achieved, which is advantageous.

It should be understood that the flow reduction refers to a reduction in an already established flow by a certain percentage relative to that flow. The flow reduction could be specified in other ways, e.g. according to a nominal flow. Such different ways of expressing the flow reduction should be considered as being within the scope of the invention.

According to an embodiment of the invention, a first supply pressure threshold is within the range of 40 bar to 250 bar, such as within the range of 50 bar to 210 bar, such as within the range of 50 bar to 150 bar, such as within the range of 60-120 bar.

Advantageously, operating the refueling system including the first flow reduction based on these ranges of the first supply pressure threshold may have the effect of providing the mentioned efficient filling of the receiving vessels while avoiding reaching temperatures that are so low that the filling of the receiving vessel must be terminated. Hence, the gas supply flow may advantageously be continued at a lower flow rate instead of being completely terminated. Also, operating withing these ranges of the first flow reduction threshold may have the effect that the peak power draw of the compression stages is reduced, and thereby a more even power draw over time is achieved, which is advantageous.

According to an embodiment of the invention, a controller of said one or more controllers is configured to control said gas supply flow in each respective supply conduits of said two or more supply conduits by controlling a compression stage capacity of each compression stage of said two or more compression stages.

Advantageously, this may have the effect that the compression stages may be regulated so as to control the gas supply flow and hence the rate at which a mobile gas supply vessel is emptied and likewise the rate at which a receiving vessel is filled.

The term compression stage capacity may, e.g., refer to the flow rate that the compression stage is able to provide at a given pressure. The compression stage capacity may be controlled in various ways, e.g. by controlling the speed (rounds per minute-RPM), the density of gas in the compression chamber of a compression stage, the suction pressure, etc.

According to an embodiment of the invention, said compression stage capacity comprises one or more of the list comprising: speed of the compression stage, cylinder capacity, gas density, clearance volume, stroke volume, suction valve control.

Advantageously, this may have the effect that the compression capacity may be regulated in various ways, e.g. by controlling the speed of the compressor, the stroke volume, clearance volume etc. Thereby, the flow rate of gas at the compressor outlet and thus, the flow rate at which a mobile gas supply vessel is emptied may be controlled by the refueling system, which is advantageous.

The term clearance volume may refer to the volume that remains in the cylinder of the compression stage when the piston is in the top center position.

The term gas density may refer to the density of the gas that is sucked into the compressor head. E.g., the density of the gas in the compression chamber of the compression stage, when, e.g., the piston is in the bottom center,

The term cylinder capacity may refer to the maximum volume of the compression chamber of the compression stage, when, e.g., the piston is at a bottom center.

According to an embodiment of the invention, each compression stage of said two or more compression stages comprises a compression inlet valve, and wherein a controller of said one or more controllers is configured to close said compression inlet valve at a defined point during a suction cycle of said compression stage.

Advantageously, this may have the effect of limiting the amount of gas that is sucked into the compression chamber of the compression stage during the suction cycle of the compression stage and thereby limiting the amount of gas, the density of gas, inside the compression chamber. Advantageously, this may limit the amount of compressed gas delivered at the outlet of the compression stage per stroke of the compression stage, and thereby reducing the gas supply flow and the gas flow to the receiving vessel. Further advantageously, this may have the effect that the gas supply flow may be reduced while keeping the speed of the compression stage constant, which is advantageous.

According to an embodiment of the invention, each compression stage of said two or more compression stages comprises a compression inlet valve, and wherein a controller of said one or more controllers is configured to open said compression inlet valve at a pressure release point during a compression stroke of said compression stage.

Advantageously, this may limit the amount of compressed gas delivered at the outlet of the compression stage per stroke of the compression stage, and thereby reducing the gas supply flow and the gas flow to the receiving vessel. Further advantageously, this may have the effect that the gas supply flow may be reduced while keeping the speed of the compression stage constant, which is advantageous.

According to an embodiment of the invention, said control said gas supply flow comprises terminating a gas supply flow in a supply conduit of said two or more supply conduits when a first supply parameter of said one or more supply parameters associated with said supply conduit crosses a second supply parameter threshold.

Advantageously, this may provide a controlled way of terminating the gas supply flow according to parameters associated with the supply conduit and/or the gas supply flow and/or a mobile gas supply vessel.

According to an embodiment of the invention, said second supply parameter threshold is a second supply pressure threshold and wherein said first supply parameter is a supply pressure.

Advantageously, this enables termination of the gas supply flows based on a pressure related threshold and a supply pressure.

The term supply pressure threshold is a threshold related to a pressure. E.g., the supply pressure threshold may specify a pressure value. It may alternatively specify a relative pressure value, or it may specify a value of a change in pressure.

According to an embodiment of the invention, said second supply pressure threshold is withing the range of 10 bar to 100 bar, such as withing the range of 20 bar to 80 bar, such as within the range of 30 bar to 60 bar, such as within the range of 28 bar to 50.

Advantageously, this may have the effect that it is possible ensure that a gas supply flow is terminated according to these specified ranges of a second supply pressure threshold. Thereby, when operating the refueling system based on these ranges, it may be possible to avoid temperatures within the refueling system dropping to critical values due to the pressure drop that occur when emptying mobile gas supply vessels, which is advantageous.

According to an embodiment of the invention, said one or more supply parameter sensors comprises at least a temperature sensor configured to measure a supply temperature of said supply conduit.

According to an embodiment of the invention, said hydrogen refueling system comprises a temperature sensor configured to measure a supply temperature of gas from said mobile gas supply conduit.

Advantageously, this may have the effect that the supply temperature may be monitored, e.g., during filling of the receiving vessel. Thereby, it is possible to operate the refueling system according to the supply temperature. E.g., it may be possible to check that the temperature is not at a critically low level, which is advantageous, e.g., since a very low supply temperature may damage the refueling system.

The term supply temperature may be a direct or an indirect measurement of the temperature of gas from one of the mobile gas supply vessels. Hence, the supply temperature may be measured in supply conduits. However, it may also be measured in the mobile gas supply vessel supplying the gas to the supply conduit or in other places of the hydrogen refueling system.

According to an embodiment of the invention, each of said supply conduits comprises a temperature sensor configured to measure a supply temperature in each said supply conduit.

Advantageously, this may have the effect that the temperature may be monitored individually in each of the supply conduits. E.g., the supply temperature may be monitored. Thereby it may, e.g., be checked that the temperature is in compliance with the temperature operating range of component. E.g., if the temperature becomes too low, it may damage parts of the hydrogen refueling system.

According to an embodiment of the invention, said control said gas supply flow in said each respective supply conduit of said two or more supply conduits comprises terminating said gas supply flow in a supply conduit of said two or more supply conduits when a supply temperature associated with said supply conduit falls below a safety temperature threshold.

Advantageously, this may have the effect of ensuring that the supply temperature does not drop further below a safety temperature threshold. The temperature drop may be caused by a pressure drop occurring during emptying of the mobile gas supply vessels, and thereby terminating the gas supply flow from a mobile gas supply vessel terminates the pressure drop and thereby the temperature drop. This may ensure that the temperature does not reaches critical levels where components of the refueling system may be damaged, which is advantageous.

The term terminate may in the present context be understood discontinued or stopped, in the sense that the flow is discontinued.

According to an embodiment of the invention, a controller of said one or more controllers is configured to control said gas supply flow in said supply conduits according to a first temperature threshold.

Advantageously, this may have the effect that the flow may be controlled to avoid reaching critically low temperature levels. Advantageously, such control may ensure continuous emptying of a gas supply vessel, without the temperature reaching levels whereat the gas supply flow would need to be terminated to avoid reaching critically low temperature levels.

It should be understood that the gas supply flow may be controlled in a variety of ways and according to different flow control schemes. E.g., the flow may be dynamically controlled according to the supply temperature, e.g., such that a certain supply temperature would result in controlling the gas supply flow to a certain flow rate. This flow control could be a linear control, but it could also be according to a non-linear dependency between the supply temperature and the gas supply flow.

According to an embodiment of the invention, a controller of said one or more controllers is configured to reduce a gas supply flow in a supply conduit of said two or more supply conduits when a supply temperature of said gas supply conduit crosses a first temperature threshold.

Advantageously, by reducing the gas supply flow, the temperature drop associated with emptying of a mobile gas supply vessel may be reduced or halted. Thereby, the emptying of the mobile gas supply vessel may be continued without the temperature reaching critically low levels, or the rate of change in the supply temperature may at least be reduced, which is advantageous.

The term crosses could be understood as both reaching below or above the threshold. Here the term crosses should be understood as reaching the first temperature threshold.

According to an embodiment of the invention, said reduction in gas supply flow is a reduction withing the range of to 10 percent to 90 percent, such as within the range of 20 percent to 80 percent.

In embodiments of the invention, the flow reduction may also be determined according to various further parameters, including, e.g., ambient temperature, the rate of change in temperature, the capacity of the vessel in comparison to the flow rate etc. to name a few non-limiting examples.

The percentage flow reduction may be understood as a percentage reduction in the flow rate relative to the flow rate of the gas supply flow.

According to an embodiment of the invention, a controller of said one or more controllers is configured to increase a gas supply flow from a mobile gas supply vessel having the highest pressure and/or state of charge of said two or more gas supply vessels, when a supply temperature of a gas supply conduit connected to another gas supply vessel of said two or more gas supply vessels exceeds said first temperature threshold.

Advantageously, this may have the effect that when a flow is reduced due to a low temperature in one supply conduit, the gas supply flow may be increased in another supply conduit and thereby counteracting the flow reduction caused by the low temperature.

According to an embodiment of the invention, a first temperature threshold is within the range of minus 60 degrees Celsius to minus 10 degrees Celsius, such as within the range of minus 50 degrees Celsius to minus 15 degrees Celsius, such as withing the range of minus 50 degrees Celsius to minus 20 degrees Celsius, such as withing the range of minus 45 degrees Celsius to minus 25 degrees Celsius, such as within the range of minus 42 degrees Celsius and minus 28 degrees Celsius.

Advantageously, this may have the effect that when the gas supply flow is controlled according to these ranges of the first supply temperature threshold, e.g., the flow reduction in the gas supply flow may be performed so that the temperature may be kept above a safety temperature threshold whereat the flow would need to be terminated to minimize the pressure drop that causes the temperature drop. Hence, the control according to the specified ranges of the first supply temperature threshold may have the effect of sustaining the supply of gas to said receiving vessel from a mobile gas supply.

According to an embodiment of the invention, a safety temperature threshold is within the range of minus 60 degrees Celsius to minus 25 degrees Celsius, such as within the range of minus 55 degrees Celsius to minus 25 degrees Celsius, such as withing the range of minus 50 degrees Celsius to minus 25 degrees Celsius, such as withing the range of minus 45 degrees Celsius to minus 30 degrees Celsius, such as within the range of minus 45 degrees Celsius to minus 35 degrees Celsius.

Advantageously, this may have the effect that operating the refueling system according to a safety temperature threshold withing these ranges, damage to refueling system components may be avoided. Furthermore, this may minimize the risk of accidental events caused by damaged components.

According to an embodiment of the invention, a controller of said one or more controllers is configured to regulate a gas supply flow a supply conduit of said two or more supply conduits according to a state of charge of a mobile gas supply vessel connected to said supply conduit of said two or more mobile gas supply vessels.

Advantageously, this may have the effect that the emptying of the mobile gas supply vessels may be regulated according to a state of charge of at least that mobile gas supply vessel. This may have the further effect that the emptying of two mobile gas supply vessels into the receiving vessel may be performed in an efficient manner, taking into account the state of charge of the mobile gas supply vessels.

The term state of charge should be understood as to encompass a rate of change in state of charge as well.

It should be understood that regulating a gas supply flow may refer to regulating a flow rage of said gas supply flow.

According to an embodiment of the invention, a controller of said one or more controllers is configured to control a flow rate of a gas supply flow in any of said two or mor supply conduits according to a state of charge threshold and according to a state of charge of each of said two or more mobile gas supply vessels.

Advantageously, this may have the effect of providing a consistent control of the emptying of mobile gas supply vessels based on a state of charge threshold. Also, it provides a control wherein based on the state of charge threshold, the emptying of mobile gas supply vessels may be controlled, e.g., such that a mobile gas supply having the highest state of charge is emptied at a higher flow rate compared to another mobile gas supply vessel with a lower state of charge. This may advantageously be more energy efficient, e.g., less energy may be spent by compression stages connected to said mobile gas supply vessels.

According to an embodiment of the invention, a controller of said one or more controllers is configured to empty a mobile gas supply vessel with a lowest state of charge of said two or more gas supply vessels at a lower flow rate than a mobile gas supply vessel of said two or more gas supply vessels with a higher state of charge of said two or more gas supply vessels.

Advantageously, by emptying the mobile gas supply vessel with a lowest state of charge at a reduced flow rate, the temperature drop caused by the pressure drop that is associated with emptying a mobile gas supply vessel may be reduced. This is further advantageous because halting the emptying of the mobile gas supply due to reaching a temperature threshold may be avoided, while still providing a sufficiently high flow rate from the mobile gas supply to the receiving vessel.

According to an embodiment of the invention, said two or more mobile gas supply vessels connected to said supply conduit arrangement have different pressures and/or different state of charge.

According to an embodiment of the invention, said gas supply comprises three or more mobile gas supply vessels, such as four or more mobile gas supply vessels, such as five or more mobile gas supply vessels, and wherein each of said mobile gas supply vessels are fluidly connectable to said supply conduit arrangement via said supply conduits.

Advantageously, this may have the effect that additional mobile gas supply vessels may be emptied simultaneously. Thereby faster filling of one or more receiving vessels may be achieved, which is advantageous.

According to an embodiment of the invention, each of said two or more supply conduits are fluidly connectable to each inlet of each compression stage of said compression arrangement.

Advantageously, this may have the effect that a mobile gas supply may be connected to any compression stage, irrespective of which supply conduit the mobile gas supply is connected to. Thereby, if a compression stage is optimized according to, e.g., a specific inlet pressure range, a mobile gas supply vessel may be fluidly connected to the compression stage that best fit the current pressure of the mobile gas supply vessel. Thereby, this may increase the efficiency of the compression arrangement.

According to an embodiment of the invention, said supply conduit arrangement comprises three or more supply conduits each having a supply valve.

Advantageously, this may have the effect that a third mobile gas supply vessel may be connected to the third supply conduit, and thereby, the emptying of the third gas supply vessel can be quickly initiated, e.g., when emptying of another connected mobile gas supply vessel is suspended, e.g., when it has been emptied. Thereby, the parallel and simultaneous emptying of two or more mobile gas supply vessels may be continued quickly by the fast swap in of a further mobile gas supply vessel via the third gas supply conduit.

According to an embodiment of the invention, each of said two or more supply conduits are fluidly connected at a to a gas distribution arrangement configured to enable a fluid connection between any mobile gas supply vessel of said two or more gas supply vessels and any compression stage of said two or more compression stages.

Advantageously, this may have the effect that any mobile gas supply vessel may supply any compression stage with gas without the need to disconnect the mobile gas supply from one supply conduit and reconnecting it at another supply conduit. Hence, the pressure provided by a given mobile gas supply vessel may be distributed to a particular compression stage, such as, e.g., a compression stage that is most efficient at the pressure provided by the mobile gas supply vessel. During emptying of mobile gas supply vessels, the pressure decreases, and the gas distribution arrangement may advantageously enable switching to the most efficient compression stage. This may, e.g., be advantageous during a mobile gas supply vessel swap where a new mobile gas supply vessel with a high pressure is connected while, e.g., a substantially emptied mobile gas supply vessel with a low pressure is disconnected.

The term gas distribution arrangement may refer to various ways of redistributing gas among the supply conduits. Non-limiting examples of the gas distribution arrangement comprises, e.g., a valve panel, a manifold, a switch valve such as a four-way valve etc.

According to an embodiment of the invention, said gas distribution arrangement comprises interconnecting conduits comprising valves, and wherein said interconnecting conduits are arranged to connect each said supply conduit of said two or more supply conduit with one another.

Advantageously, this may provide a way to redistribute gas from any mobile gas supply vessel to any compression stage via the mobile supply conduits and the interconnecting conduits. E.g., when on mobile gas supply vessel connected to a compression stage via a supply vessel is empty, another mobile gas supply vessel connected to a different supply conduit may be quickly connected to that compression stage via an interconnecting conduit, and thereby the gas supply flow to that compression stage and to the receiving vessel may be continued quickly, which is advantageous. Moreover, the interconnecting conduits enable the gas supply flow to be redirected to a compression stage optimized to a pressure range encompassing the pressure of that gas supply flow, which is advantageous.

According to an embodiment of the invention, when a first supply parameter of said one or more supply parameters associated with a supply conduit of said two or more supply conduits crosses a second supply parameter threshold, a controller of said one or more controllers is configured to control said gas distribution arrangement to discontinue a gas supply flow in said supply conduit from a mobile gas supply vessel of said two or more gas supply vessels, and to establish a gas supply flow from another mobile gas supply vessel of said two or more gas supply vessels.

Advantageously, this has the effect of providing a consistent way of discontinuing (terminating) emptying of a mobile gas supply vessel and at the same time starting emptying from another gas supply vessel into the receiving vessel. In other words, this advantageously provides swapping of mobile gas supply vessels. E.g., swapping of a substantially empty mobile gas supply vessel with another mobile gas supply vessel containing more gas.

The term crosses may be understood to encompass both the supply parameter rising above the supply parameter threshold and the parameter falling below the supply parameter threshold.

According to an embodiment of the invention, said control of said gas distribution arrangement comprises a controller of said one or more controllers being configured to switch valves of said gas distribution arrangement between a closed state and an open state.

Advantageously, this may have the effect the flow of fluid in the refueling system may be controlled automatically by one or more controllers, which his advantageous.

According to an embodiment of the invention, said supply system comprises one or more heat exchangers thermally coupled to one or more supply conduits of said two or more supply conduits.

Advantageously, this may have the effect of reducing the cooling of the supply system and other components of the hydrogen refueling station, which may happen during the emptying of mobile gas supply vessels. Thereby, the mobile gas supply vessels may be emptied faster, while keeping the temperature within a sufficient operating range.

According to an embodiment of the invention, said heat exchanger is coupled to a cooling system of said hydrogen refueling station, wherein said cooling system of said hydrogen is configured to cool hydrogen during a refueling operation.

Advantageously, this has the effect that the heat generated during refueling operations may be used to supply heat via the one or more heat exchangers to the supply system, and thereby the flowrate at which a mobile gas supply may be emptied may be increased while keeping the temperature of, e.g., the supply system withing a sufficient operating range.

In the present context, the term coupled should be understand as thermally coupled and/or fluidly coupled. Whether a fluid coupling is used or a thermal coupling without a direct fluid coupling is used may depend on the particular implementation of the invention.

According to an embodiment of the invention, said heat exchanger is coupled with a cooling buffer of said cooling system.

Advantageously, this has the effect that temperature drop that may occur as a result of the pressure drop happening during the emptying of mobile gas supply vessels may be used to build up a cooling buffer. The cooling buffer may be used for cooling hydrogen, e.g., during a refueling operation, which is advantageous. Altogether, this may further minimize the energy consumption of the cooling system by providing the ability to store the thermal energy.

Notice that the term coupled may refer to a thermal coupling and also to a fluid coupling.

According to an embodiment of the invention, each compression stage of said two or more compression stages is a compressor.

According to an embodiment of the invention, at least two compression stages of said two or more compression stages are compression stages of a multistage compressor.

Advantageously, this may have the effect of minimizing the size and/or the physical footprint of the compression stages, e.g., compared to having to separate compression stages, such as, e.g., separate compressors.

According to an embodiment of the invention, said compression arrangement comprises at least two to eight compression stages, such as at least two to five compression stages, such as at least two to four compression stages, such as at least three to four compression stages, such as at least three compression stages.

Advantageously, a compression arrangement comprising between two to eight compression stages provides a flexible refueling system capable of effectively emptying mobile gas supply vessels with a broad range of different pressures. E.g., by optimizing the compression stages to operate efficiently at inlet different pressures, different compression ratios, etc. Moreover, this may enable simultaneous emptying of as much as eight mobile gas supply vessels, depending on the particular implementation of the invention, which is advantageous.

According to an embodiment of the invention, said hydrogen refueling system comprises one or more cascade conduits comprising a cascade valve and each one or more cascade conduits having an upstream end connectable to a mobile gas supply of said two or more mobile gas supply vessels and a downstream end connected to said common outlet and/or said receiving vessel.

Advantageously, this may have the effect a mobile gas supply vessel may be connected to a cascade conduit and thereby the mobile gas supply vessel may supply gas to the receiving vessel while bypassing the compression arrangement. This may, e.g., be advantageous when a mobile gas supply has a pressure sufficiently high to not require further compression. Thereby, this may minimize the energy consumption of the refueling system.

According to an embodiment of the invention, said two or more compression stages are serially connected.

Advantageously, this may provide a stepwise increase in pressure for each compression stage. Thereby, the compression stages may in a collaborative way increase the pressure to provide a required pressure at the common outlet. Moreover, the serial arrangement of compression stages may be effective compared to other arrangements of compression stages.

In the present context, serially connected refer to the compression stages being fluidly connected. E.g., the outlet of one compression stage of the two or more compression stages being fluidly connected with an inlet of a further compression stage of the two or more compression stages.

According to an embodiment of the invention, an outlet of a first compression stage of said two or more compression stages is connected to said common outlet via said second compression stage.

Advantageously, this enables a first compression stage to supply an inlet of a second compression stage. Thereby, the compression ratio provided by each compression stage may be minimized. Thereby, the compression arrangement may be more efficient, e.g., the energy consumption of the compression arrangement may be minimized.

According to an embodiment of the invention, a compression outlet of a first compression stage is connected to a supply conduit connected to an inlet of a following compression stage, and wherein a controller of said one or more controllers is configured to control an outlet pressure of said first compression stage to be substantially equal to a supply pressure of a gas supply flow in said supply conduit connected to an inlet of a following compression stage.

Advantageously, this enables efficient supply of gas from one compression stage to a following compression stage, even when a gas supply flow is simultaneously supplied to the following compression stage. Thereby, this may provide efficient emptying of two mobile gas supply vessels separately connected to the two mentioned compression stages.

According to an embodiment of the invention, said each compression stage of said two or more compression stages is optimized according to a different inlet pressure range and/or compression ratios.

Advantageously, this may have the effect of providing an energy efficient compression arrangement. E.g., the compression arrangement may thereby accommodate mobile gas supply vessels with various different pressures. E.g., gas supply flow from a mobile gas supply vessel having a low pressure may be supplied to a compression stage of the compression arrangement that is best suited to handle that pressure, while another mobile gas supply having a higher pressure may be emptied using a different compression stage that better match the particular pressure of that mobile gas supply vessel.

According to an embodiment of the invention, a compression stage of said two or more compression stages is optimized according to a compression ratio within the range of 1.5 to 8, such as between 2 to 6, such as 2.5 to 4.

According to an embodiment of the invention, a first compression stage of said two or more compression stages is optimized according to a compression ratio within the range of 1.5 to 8, such as between 2 to 6, such as 2.5 to 4.

According to an embodiment of the invention, an outlet of a last compression stage of said two or more compression stages is connected to said common outlet.

The term last compression stage may in the present context refer to the last compression stage of, e.g., two or more serially coupled compression stages.

According to an embodiment of the invention, a last compression stage of said two or more compression stages provides an outlet pressure withing the range of 100 bar to 1500 bar, such as within the range of 200 bar to 1100 bar, such as within the range of 200 bar to 1050, such as within the range of 200 bar to 950 bar, such as an outlet pressure equal to or above 200 bar.

According to an embodiment of the invention, a controller of said one or more controllers control said two or more compression stages to provide different compression ratios.

Advantageously, this may have the effect of enabling the gas supply flow in the gas supply conduits to have different flow rates.

In the present context, the term different compression ratio may be understood as one compression stage being controlled to provide a compression ratio that is different to a compression ratio provided by another compression stage.

Furthermore, it should be understood that some embodiments of the invention may optionally comprise additional compression stages, and that these stages may also be controlled to provide compression ratios that are different from compression ratios provided by other compression stages.

According to an embodiment of the invention, said two or more compression stages are arranged in parallel.

Advantageously, this may have the effect that each compression stage may receive a gas supply flow from a separate mobile gas supply and compress the gas supply flow to supply compressed gas to a receiving vessel from two mobile gas supply vessels simultaneously.

According to an embodiment of the invention, an outlet of each of said compression stage of said two or more compression stages are directly fluidly connected to said common outlet.

Advantageously, this may enable a flow of gas from two mobile gas supply vessels connected to individual compression stages of a hydrogen refueling station to be combined at a common outlet. The gas flow at the common outlet may, e.g. be utilized for filling a receiving vessel, which is advantageous.

In the present context, the term directly specifies that the outlets of the compressors are connected directly to the common outlet and not necessarily via a further compression stage.

According to an embodiment of the invention, a controller of said two or more controllers control said two or more compression stages to provide a substantially equal outlet pressure.

Advantageously, this may have the effect that the flow of gas at the outlet of each compressor may be combined to, e.g. effectively fill a receiving vessel with gas.

According to an embodiment of the invention, said outlet pressure is withing the range of 100 bar to 1500 bar, such as within the range of 200 bar and 1100 bar, such as within the range of 200 bar to 1050, such as within the range of 200 bar to 950 bar, such as equal to or above 200 bar.

According to an embodiment of the invention, each of said two or more compression stages is operated at different compression ratios.

Advantageously, this may have the effect that even if different supply pressures are provided at the inlet of the two or more compression stages, the compression stages may still provide a substantially equal outlet pressure, thereby, enabling effectively filling of a receiving vessel with compressed gas from two separate mobile gas supply vessels.

The invention further relates to a method of filling a receiving vessel; wherein said method comprises: providing a first mobile gas supply vessel of a mobile gas supply; fluidly connecting said first mobile gas supply vessel to a first supply conduit fluidly connected to a receiving vessel via a first compression stage and a common outlet; providing a second mobile gas supply vessel of a mobile gas supply; fluidly connecting said second mobile gas supply vessel to a second supply conduit fluidly connected to said receiving vessel via a second compression stage and said common outlet; establishing a gas supply flow from said mobile gas supply to said receiving vessel, wherein said gas supply flow comprises one or more gas supply flows, including at least a first gas supply flow and a second gas supply flow, and wherein said first gas supply flow from said first mobile gas supply vessel to said receiving vessel via said first gas supply conduit, said first compression stage and said common outlet; and wherein said second gas supply flow from said second mobile gas supply vessel to said receiving vessel via said second gas supply conduit, said second compression stage and said common outlet; controlling a flow rate of said first gas supply flow in said first supply conduit and a flow rate of said second gas supply flow in said second supply conduit to be different; and wherein said first compression stage is configured to establish an outlet pressure substantially at least equal to an inlet pressure of said second compression stage.

Advantageously, the invention enables filling of a receiving vessel with gas transferred simultaneously from two mobile gas supply vessels to the receiving vessel.

By filling from two separate mobile gas supply vessels simultaneously, the rate at which the receiving vessel is filled may be kept high, while at the same time the pressure drops and thereby the temperature drop may be kept above critical levels at which the filling would otherwise need to be halted. Thereby, the total refilling capacity may be increased since the rate of filling may be higher compared to traditional systems.

It should be understood that when referring to, e.g., the first gas supply vessel and the second gas supply vessels having different pressures, this may refer to the gas pressure inside the two gas supply vessels being different. Furthermore, it should be understood that the term first and second does not imply any specific order.

It should be understood that the terms first compression stage and second compression stage may be understood as referring to two individual compressors, or it may be understood as referring to at least two compression stages of, e.g., a single multistage compressor. Moreover, it should be understood that the first compression stage may refer to a multistage compressor or to a single stage compressor, and that the second compression stage may refer to a multistage compressor or to a single stage compressor.

The first compression stage and the term second compression stage may be identical or different. Hence it should be understood that the statement that the first compression stage establishes an outlet pressure that is substantially at least equal to an inlet pressure of said second compression stage may be understood as one compression stage of the two mentioned compression stages establishing an outlet pressure that is substantially at least equal to an inlet pressure of the other compression stage of the two compression stages. Thus, in the present context, the term first and second compression stage does not necessarily imply, e.g., a particular order of arrangement of/supply to the two compression stages. Therefore, according to an embodiment of the invention said first compression stage is configured to establish an outlet pressure substantially at least equal to an inlet pressure of said second compression stage or said second compression stage is configured to establish an outlet pressure substantially at least equal to an inlet pressure of said first compression stage.

The term outlet pressure may refer to the pressure established by a compression stage at the outlet of the compression stage.

The term inlet pressure may refer to the pressure at the inlet of the compression stage.

The term substantially equal may be used to describe that a given quantity or parameter is close to or equal to another parameter, quantity or threshold.

According to an embodiment of the invention, said method is configured to be performed by said hydrogen refueling system.

According to an embodiment of the invention, said gas transferring method is controlled by one or more controllers of said hydrogen refueling system.

Advantageously, this has the effect of providing automatic control of the gas transferring method.

According to an embodiment of the invention, said gas is hydrogen.

Advantageously, this has the effect of enabling refilling of a receiving vessel of the hydrogen refueling station with hydrogen from two mobile gas supply vessels.

According to an embodiment of the invention, said first mobile gas supply vessel and said second mobile gas supply vessel have different pressures.

According to an embodiment of the invention, said method comprises obtaining one or more supply parameters associated with one or more of the lists comprising: said first gas supply flow, said second gas supply flow, said first mobile gas supply vessel, said second mobile gas supply vessel.

According to an embodiment of the invention, said first gas supply flow in said first supply conduit and said second gas supply flow in said second supply conduit is controlled according to at least one of a first gas supply flow target and a second gas supply flow target.

Obtaining should be understood as to comprise measuring.

According to an embodiment of the invention, said second gas supply flow target is substantially between 10 percent to 60 percent of said first gas supply flow target, such as between 15 percent to 50 percent of said first gas supply flow target, such as between 24 percent to 45 percent of said first gas supply flow target.

According to an embodiment of the invention, said first gas supply flow target is a higher flow rate than said second gas supply flow target, and wherein a flow rate of a gas supply flow of a supply conduit of said first supply conduit and said second supply conduit having a highest supply pressure is controlled according to said first gas supply flow target.

Advantageously, this may have the effect that the mobile gas supply vessel having the highest pressure is emptied at a faster rate. This may have the effect of increasing the overall efficiency of the emptying of the mobile gas supply vessels.

According to an embodiment of the invention, said method comprises a step of reducing a flow rate of said first gas supply flow of said first supply conduit by a first flow reduction when a first supply parameter associated with said first supply conduit of said one or more supply parameters crosses a first supply parameter threshold and/or reducing a flow rate of said second gas supply flow of said first supply conduit with a first flow reduction when a first supply parameter associated with said second supply conduit of said one or more supply parameters exceeds a first supply parameter threshold.

Advantageously, this may provide a flow reduction of the gas supply flow, when a first supply parameter crosses a first supply parameter threshold. E.g., in some situations, reducing the gas supply flow may affect the first supply parameter in such a way that the first supply parameter is moved further away from the first supply parameter threshold. Thereby, the refueling system may be able to respond according to a first supply parameter crossing a first supply parameters threshold, and thereby, the flow may be reduced in time to, e.g., avoid a complete termination of the gas supply flow, which is advantageous, since the filling of the receiving vessel may be continued instead of being completely halted.

The term crossing may refer to a value or parameter falling below a threshold or to a value or parameter exceeding a threshold.

According to an embodiment of the invention, said a first supply parameter of said one or more supply parameters includes one or more of the list comprising: supply pressure, supply temperature, state of charge of one or more of said two or more mobile gas supply vessels, gas supply flow.

Advantageously, this may have the effect that the gas supply flow may be regulated according to various parameters related to mobile gas supply and to the supply conduits, and hence the gas supply flow may be adapted to changes in various parameters. E.g., it may be advantageous to control the gas supply flow in individual supply conduits according to the state of charge of a mobile gas supply connected to that supply conduit. Moreover, it may be advantageous to control the individual gas supply flow according to supply temperature, supply pressure etc., e.g., to ensure that the emptying of the mobile gas supply is performed in such a way that it complies with regulations and safety limits.

According to an embodiment of the invention, said first flow reduction is a reduction of said flow rate within the range of a 40 percent to 80 percent reduction, such as within the range of a 50 percent to 70 percent reduction, such as within the range of a 60 percent to 66 percent reduction.

According to an embodiment of the invention, said method comprises a step of increasing a flow rate in a supply conduit of said first supply conduit and said second supply conduit when reducing a flow rate in another supply conduit of said first supply conduit and said second supply conduit.

Advantageously, this may have the effect of maintaining a sufficient flow from the mobile gas supply to a receiving vessel, even when a flow from one mobile gas supply is reduced.

According to an embodiment of the invention, said method comprises a step of terminating said first gas supply flow in said first supply conduit and/or a said second gas supply flow in said second supply conduit when a first supply parameter of said one or more supply parameters crosses a second supply parameter threshold.

Advantageously, this may provide a controlled way of terminating the gas supply flow according to parameters associated with the supply conduit and/or the gas supply flow and/or a mobile gas supply vessel.

According to an embodiment of the invention, said method comprises a step of swapping a third mobile gas supply vessel with a mobile gas supply vessel to be swapped of said first and said second mobile gas supply vessels, wherein said mobile gas supply vessel to be swapped is associated with a first supply parameter crossing a second supply parameter threshold.

Advantageously, this may have the effect of enabling a controlled swapping of mobile gas supply vessels according to a first supply parameter and a second supply parameter threshold.

It should be understood that the swapping may be performed in various ways.

According to an embodiment of the invention, said step of swapping a third mobile gas supply vessel comprises: fluidly connecting said third mobile gas supply vessel to a third supply conduit fluidly connectable to any of said first compression stage and said second compression stage; fluidly disconnecting a supply conduit from a compression stage of said first compression stage and said second compression stage, wherein said supply conduit is connecting said mobile gas supply vessel to be swapped with said compression stage; fluidly connecting said third supply conduit to an unoccupied compression stage of said first and said second compression stage to establish a gas supply flow from said third mobile gas supply vessel to said receiving vessel via said third gas supply conduit, said unoccupied compression stage and said common outlet.

Advantageously, this may have the effect of providing a quick and seamless swapping, including an efficient termination of gas supply flow from the mobile gas supply vessel to be swapped, and a quick establishment of gas supply flow from the third mobile gas supply vessel.

According to an embodiment of the invention, said second supply parameter threshold is includes one or more of the lists comprising a second supply pressure threshold, a second state of charge threshold, a second supply temperature threshold, a second gas supply flow threshold.

Advantageously, various second supply parameters threshold may be utilized, thereby enabling a method that is flexible with regard to parameters that may be used to control, e.g., gas supply flow and swapping of mobile gas supply vessels.

According to an embodiment of the invention, said second supply pressure threshold is withing the range of 10 bar to 100 bar, such as withing the range of 20 bar to 80 bar, such as within the range of 30 bar to 60 bar, such as within the range of 30 bar to 50.

Advantageously, this may have the effect that it is possible ensure that a gas supply flow is terminated according to these specified ranges of a second supply pressure threshold. Thereby, when operating the refueling system based on these ranges, it may be possible to avoid temperatures within the refueling system dropping to critical values due to the pressure drop that occur when emptying mobile gas supply vessels, which is advantageous.

According to an embodiment of the invention, said method comprises measuring a supply temperature of said first gas supply flow and/or of said second gas supply flow.

Advantageously, this may have the effect that the supply temperature may be monitored, e.g., during filling of the receiving vessel. Thereby, it is possible to control the filling of the receiving vessel according to the supply temperature. E.g., it may be possible to check that the temperature is not at a critically low level, which is advantageous, e.g., since a very low supply temperature may damage components of, e.g., a refueling system performing the method.

It should be understood that the supply temperature could be obtained in various ways, e.g., by measuring indirectly or directly the supply temperature of the gas, e.g., using one or more temperature sensors. The temperature sensors may be placed various places as long as the temperature sensors are capable of measuring the supply temperature.

According to an embodiment of the invention, each said one or more gas supply flows is controlled according to a first temperature threshold.

Advantageously, this may have the effect that the flow may be controlled to avoid reaching critically low temperature levels. Advantageously, such control may ensure continuous emptying of a gas supply vessel, without the temperature reaching levels whereat the gas supply flow would need to be terminated to avoid reaching critically low temperature levels.

It should be understood that the gas supply flow may be controlled in a variety of ways and according to different flow control schemes. E.g., the flow may be dynamically controlled according to the supply temperature, e.g., such that a certain supply temperature would result in controlling the gas supply flow to a certain flow rate. This flow control could be a linear control, but it could also be according to a non-linear dependency between the supply temperature and the gas supply flow.

According to an embodiment of the invention, a gas supply flow of said one or more gas supply flows is reduced when a supply temperature of said gas supply flow of said one or more gas supply flows falls below a first temperature threshold.

Advantageously, by reducing the gas supply flow, the temperature drop associated with emptying of a mobile gas supply vessel may be reduced or halted. Thereby, the emptying of the mobile gas supply vessel may be continued without the temperature reaching critically low levels, or the rate of change in the supply temperature may at least be reduced, which is advantageous.

According to an embodiment of the invention, a first temperature threshold is within the range of minus 60 degrees Celsius to minus 10 degrees Celsius, such as within the range of minus 50 degrees Celsius to minus 15 degrees Celsius, such as withing the range of minus 50 degrees Celsius to minus 20 degrees Celsius, such as withing the range of minus 45 degrees Celsius to minus 25 degrees Celsius, such as within the range of minus 42 degrees Celsius and minus 28 degrees Celsius.

According to an embodiment of the invention, a gas supply flow of said one or more gas supply flows is terminated when a supply temperature of said gas supply flow of said one or more gas supply flows falls below a safety temperature threshold.

Advantageously, this may have the effect of ensuring that the supply temperature does not drop further below a safety temperature threshold. The temperature drop may be caused by a pressure drop occurring during emptying of the mobile gas supply vessels, and thereby terminating the gas supply flow from a mobile gas supply vessel terminates the pressure drop and thereby the temperature drop. This may ensure that the temperature does not reaches critical levels where components of the refueling system may be damaged, which is advantageous.

According to an embodiment of the invention, a safety temperature threshold is within the range of minus 60 degrees Celsius to minus 25 degrees Celsius, such as within the range of minus 55 degrees Celsius to minus 25 degrees Celsius, such as withing the range of minus 50 degrees Celsius to minus 25 degrees Celsius, such as withing the range of minus 45 degrees Celsius to minus 30 degrees Celsius, such as within the range of minus 45 degrees Celsius to minus 35 degrees Celsius.

According to an embodiment of the invention, a supply pressure associated with a gas supply flow of said one or more gas supply flows crosses a first pressure threshold, said gas supply flow is redirected to a different compression stage of said first compression stage and said second compression stage.

Advantageously, this may enable a more efficient compression of the gas supply flow. E.g., this may have the effect that a gas supply flow may be redirected to a compression stage that may, e.g., be more efficient at the pressure of that gas supply flow, which is advantageous.

According to an embodiment of the invention, said first compression stage and said second compression stage provide different compression ratios.

Advantageously, this may have the effect that gas supply flow that requires a high degree of compression to, e.g., fill a receiving vessel may be led to a compression stage providing a large compression ratio. Likewise, high pressure gas supply flow may be led to a compression stage providing a comparatively lower compression ratio. Hence, this provides a flexible compression arrangement capable of handling different inlet pressures (gas supply pressures), which is advantageous.

In the present context, the term different compression ratio may be understood as the first compression stage being controlled to provide a compression ratio that is different to a compression ratio provided by the second compression stage.

Furthermore, it should be understood that some embodiments of the invention may optionally comprise additional compression stages, and that these stages may also be controlled to provide compression ratios that is different from compression ratios provided by other compression stages in the gas transferring method.

According to an embodiment of the invention, said method comprises a step of establishing a gas supply flow from a mobile gas supply vessel of a mobile gas supply to said common outlet and/or to said receiving vessel by bypassing any of said compression stages, when a supply pressure of a supply conduit and/or a pressure of a mobile gas supply vessel exceeds a pressure in said receiving vessel and/or a pressure in said common outlet.

Advantageously, this may have the effect that the receiving vessel may be filled more efficiently, since it may, e.g., limiting the energy consumption of the compression stages.

The invention further relates to a use of a hydrogen refueling system according for filling a receiving vessel according to the method.

The invention further relates to a hydrogen refueling station of said hydrogen refueling system, wherein said hydrogen refueling station comprises: a common outlet fluidly connectable to a receiving vessel; a compression arrangement including two or more compression stages each having an inlet and an outlet; and wherein said two or more compression stages are fluidly connected to said common outlet, and wherein at least one compression stage of said two or more compression stages is configured to establish an outlet pressure substantially at least equal to an inlet pressure of a second compression stage of said two or more compression stages.

### THE DRAWINGS

Various embodiments of the invention will in the following be described with reference to the drawings where

FIG. 1 illustrates a hydrogen refueling system according to an embodiment of the invention, and

FIG. 2 illustrates a hydrogen refueling system with serially arranged compression stages according to an embodiment of the invention, and

FIG. 3 illustrates a hydrogen refueling system with parallelly arranged compression stages, according to an embodiment of the invention, and

FIG. 4 illustrates a compression arrangement and a supply conduit arrangement comprising interconnecting conduits according to an embodiment of the invention, and

FIG. 5 illustrates a common outlet, a compression arrangement and a supply conduit arrangement with cascade conduits according to an embodiment of the invention, and

FIG. 6 illustrates a hydrogen refueling system comprising three mobile gas supply vessels and a supply conduit arrangement comprising interconnecting conduits according to an embodiment of the invention, and

FIG. 7 illustrates a hydrogen refueling system with supply parameter sensors and serially arranged compression stages according to an embodiment of the invention, and

FIG. 8 illustrates a hydrogen refueling system according to an embodiment of the invention comprising supply parameter sensors and parallelly arranged compression stages according to an embodiment of the invention, and

FIG. 9 illustrates a hydrogen refueling system with pressure and temperature sensors and serially arranged compression stages according to an embodiment of the invention, and

FIG. 10 illustrates a representation of a flow control strategy based on supply pressure according to an embodiment of the invention, and

FIG. 11 illustrates a representation of a flow control strategy based on state of charge according to an embodiment of the invention, and

FIG. 12 illustrates a representation of a flow control strategy with a swing in strategy based on supply pressure according to an embodiment of the invention, and

FIG. 13 illustrates a representation of a flow control strategy with a swing in strategy based on state of charge according to an embodiment of the invention.

### DETAILED DESCRIPTION

The following section comprises a detailed description of the invention with reference to the figures.

The description comprises nonlimiting examples of embodiments of the invention. Details such as a specific methods and system structures, conduits, arrangements and components are provided to give an understanding of embodiments of the invention. Note that detailed descriptions of well-known methods, systems, components, devices, arrangements, electrical circuits, materials etc. including e.g. control leads, electrical circuits, refueling dispensers and further gas storages etc. have been omitted so as to not obscure the description of the invention with unnecessary details. It should be understood that the invention is not limited to the particular examples described below, and that a person skilled in the art may choose to implement the invention in alternative embodiments without these specific details. Furthermore, it should be understood that the skilled person may choose to combine features of the described embodiments and of the illustrated embodiments of the invention. As such, the invention may be designed and altered in a multitude of varieties within the scope of the invention, as specified in the claims.

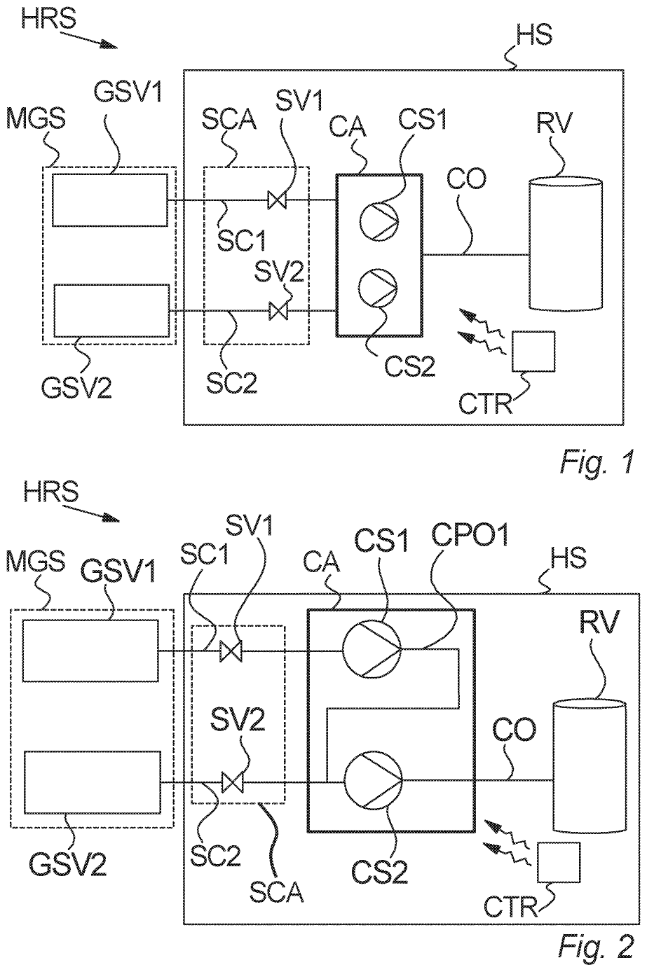

FIG. 1 illustrates a hydrogen refueling system HRS according to an embodiment of the invention. The hydrogen refueling system comprises a mobile gas supply MGS with two mobile gas supply vessels GSV1; GSV2, which in this embodiment is connected to a hydrogen refueling station HS. The hydrogen refueling station of the hydrogen refueling system comprises a supply conduit arrangement SCA with two separate supply conduits SC1; SC2 each comprising a supply valve SV1; SV2, a compression arrangement CA with two compression stages CS1; CS2, a common outlet CO and a controller CTR. The common outlet CO is fluidly connectable to a receiving vessel RV. In this exemplified embodiment, the common outlet is a conduit that is connected to the receiving vessel RV, which is a storage vessel configured to store gas. The compression stages of the compression arrangement is configured to receive a fluid at an inlet of the compression stage and to compress the fluid and to deliver the compressed fluid at an outlet of the compression stage (sometimes referred to a compression outlet).

In this embodiment, each of the two mobile gas supply vessels GSV1; GSV2 is separately connected to one of the compression stages CS1, CS2 via one of the two supply conduits SC1; SC2. Described in an alternative way, the first mobile gas supply vessel GSV1 is connected to a first compression stage CA1 via a first supply conduit SC1, and the second mobile gas supply vessel GSV2 is connected to a second compression stage CS2 via a second supply conduit SC2 of the two supply conduits SC1; SC2. Each mobile gas supply vessel GSV1; GSV2 can thus provide a gas supply flow to an individual compression stage when the supply valves SV1; SV2 are opened. The compression arrangement CA comprising the two compression stages is connected to the receiving vessel via the common outlet CO, and thereby the receiving vessel RV can receive compressed gas from the two mobile gas supply vessels GSV1; GSV2, when the compression stages are active and the supply valves SV1; SV2 are open.

During a filling of the receiving vessel RV, the two mobile gas supply vessels are fluidly connected separately to a supply conduit SC1; SC2. The controller then opens the supply valves SV1; SV2 and activates the compression stages and thereby, parallel and separate gas supply flows are established from each mobile gas supply vessel to a separate compression stage CS1; CS2 via each of the two supply conduits SC1; SC2. The compression stages compress the gas received form the mobile gas supply vessels GSV1; GSV2 and delivers the received gas to the receiving vessel RV via the common outlet CO. Thereby, the receiving vessel is filled with gas from two separate mobile gas supply vessels simultaneously.

In this exemplified embodiment of the invention, the receiving vessel is a storage vessel comprised by the hydrogen refueling station HS. However, the hydrogen refueling system HRS may also be connected to other types of receiving vessels, e.g., receiving vessels that are not necessarily part of the hydrogen refueling station, including, e.g., a receiving vessel of a vehicle, e.g., a hydrogen fueled vehicle.

FIG. 2 illustrates a hydrogen refueling system HRS with a compression arrangement CA comprising serially coupled compression stages CS1; CS2 according to an embodiment of the invention. Similar to the embodiment illustrated in FIG. 1, this embodiment further comprises a mobile gas supply MGS with two mobile gas supply vessels GSV1; GSV2, a hydrogen refueling station HS comprising a supply conduit arrangement with two supply conduits SC1; SC2 with supply valves SV1; SV2, a common outlet CO, a receiving vessel, and a controller CTR configured to control the state of the supply valves SV1; SV2 between an open state and a closed state, and further configured to control the operation of the compression arrangement CA.

The first mobile gas supply vessel GSV1 is connected to the first compression stage CSI via a first supply conduit SC1 of the two supply conduits, while the second mobile gas supply vessel GSV2 of the two supply conduits is connected to a second compression stage CS2 via a second supply conduit SC2. The mobile gas supply vessels are connected to the upstream end of the supply conduits, while the other end of each supply conduit, which is connected to respective compression stages CS1; CS2, can be designated the downstream end of the supply conduits SC1; SC2. The two compression stages CS1; CS2 are connected in serial. Hence, the compression outlet CPO1 of the first compression stage CS1 is connected to the inlet of the second compression stage CS2, and thereby, the first compression stage is connected to the common outlet CO and hence to the receiving vessel via the second compression stage CS2.

During a refueling of the receiving vessel (also referred to as a filling), a flow of gas is established from each mobile gas supply vessel to the receiving vessel. The gas flow from the first mobile gas supply vessel GSV1 to the receiving vessel is established by the controller which opens the first supply valve SVI and furthermore, the controller activates the first compression stage. Thereby a gas supply flow is established in the first supply conduit to the inlet of the first compression stage. The first compression stage then compresses the gas supply flow and deliver compressed gas supply flow at the first compression outlet CPO1 of the compressor, which is led to the inlet of the second compression stage. Meanwhile, the second gas supply flow of gas from the second mobile gas supply vessel GSV2 is established in the second supply conduit SC2 by the controller, which opens the second supply valve SV2 substantially at the same time as the first supply valve SV1 is opened. The controller also activates the second compression stage CS2. The flow from the first compression outlet is thereby mixed with the second gas supply flow from the second mobile gas supply GSV2 at the inlet of the second compression stage. The second compression stage CS2 compresses the received gas and thereby delivers compressed gas to the receiving vessel via the common outlet.

In this example, the controller operates the first compression stage CS1 at a lower compression capacity compared to the second compression stage CS2, and thereby, gas supply flow from the first mobile gas supply GSV1 is lower compared to the second gas supply flow from the second mobile gas supply flow. Thereby, the first gas supply vessel GSV1 is emptied at a lower rate compared to the rate at which the second mobile gas supply vessel GSV2 is emptied. Thereby, the pressure in the first mobile gas supply GSV1 drops slower relative to the pressure drop in the second gas supply vessel GSV2. Thereby, the temperature drop related to the emptying of the first mobile gas supply is also less than the temperature drop related to the emptying of the second mobile gas supply vessel GSV2. Advantageously, since the receiving vessel is filled from two gas supply vessels GSV1; GSV2 simultaneously, the filling rate may be elevated compared to refueling systems only capable of filling from one mobile gas supply vessel. Also, by keeping the first gas supply flow at a relatively lower rate than the second gas supply flow, the temperature may be kept above critical levels whereat the flow would need to be halted, e.g., due to risk of damaging components. Also the simultaneous emptying of two mobile gas supply vessels increases the rate at which gas may be supplied to the hydrogen refueling station.

Notice that the controller may control the compression capacity of each of the two compression stages in a variety of ways, and thereby the gas supply flow to the compression stages and the outlet pressure and the flow at the compressor outlets may be controlled in various ways. E.g., optionally, the controller may regulate the compressor speed, e.g., decreasing the speed (RPM) of the compressor to decrease the gas supply flow. Furthermore, optionally, the stroke volume of gas may also be regulated by the controller to increase or decrease the compression capacity to e.g. vary the gas supply flow. E.g., the compression stroke volume may be decreased by limiting the density of gas in the compression chamber of a compression stage. This could be achieved in various ways. E.g., optionally, the inlet to the compression stage may comprise an inlet valve, and the stroke volume may be decreased by closing the inlet valve at some point during the suction stroke (when gas is sucked into the compression chamber) to limit the influx of gas into the compression chamber of the compression stage. In an alternative optional embodiment, the stroke volume of gas provided at the compression outlet may be reduced by opening the inlet valve during the compression stroke of the compression stage.

In this embodiment, the compression arrangement is a multistage compressor, and each of the two compression stages are compression stages of the multistage compressor. However, the skilled person would appreciate that the compression stages of the invention in general may be implemented in various ways. E.g., by implementing each of the two compression stages as individual compressors. Moreover, the skilled person would appreciate that the hydrogen refueling system may be implemented using different kinds of compressors. Non-limiting examples of such different kinds of compressors could, e.g., include diaphragm compressors and piston compressors.

Optionally, the first compression stage may be controlled by the controller to deliver an outlet pressure substantially equal to the pressure of the second gas supply flow, e.g., substantially equal to the pressure in the second supply conduit SC2.

In this exemplified embodiment, one controller is applied to control the compression stages and valves. However, optionally, these tasks may be performed by a plurality of controllers.

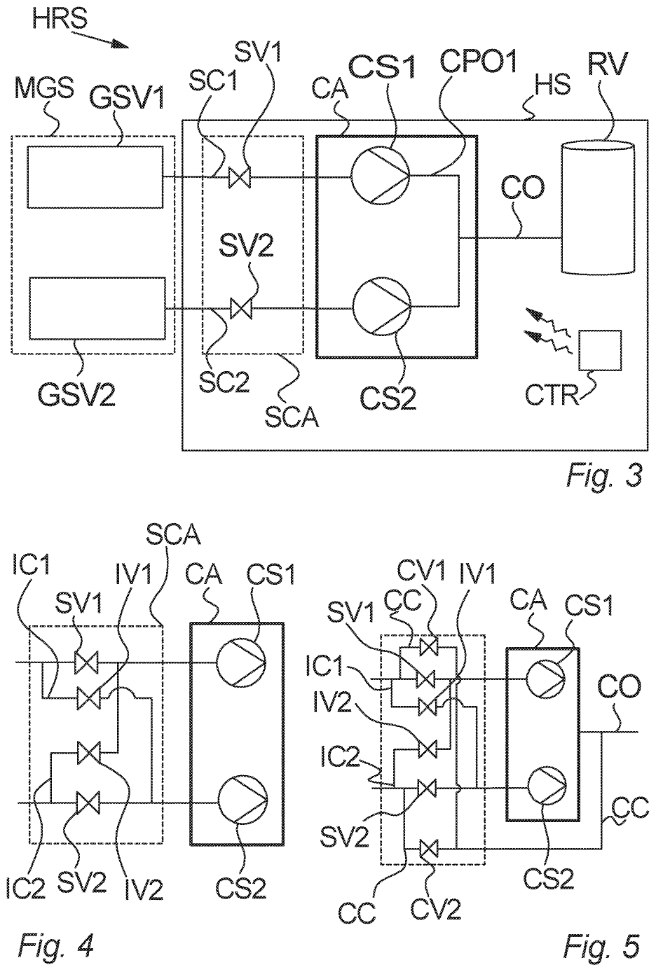

FIG. 3 illustrates a hydrogen refueling system HRS with a compression arrangement CA comprising parallelly arranged compression stages CS1; CS2 according to an embodiment of the invention. Similar to the embodiment illustrated in FIG. 1 and FIG. 2, this embodiment further comprises a mobile gas supply MGS with two mobile gas supply vessels GSV1; GSV2, a hydrogen refueling station HS comprising a supply conduit arrangement with two supply conduits SC1; SC2 with supply valves SV1; SV2, a common outlet CO, a receiving vessel RV, and a controller CTR configured to control the state of the supply valves SV1; SV2 between an open state and a closed state, and further configured to control the operation of the compression arrangement CA.

The first mobile gas supply vessel GSV1 is connected to the first compression stage CS1 via a first supply conduit SC1, while the second mobile gas supply vessel GSV2 is connected to the second compression stage CS2 via the second supply conduit SC2. The mobile gas supply vessels are connected to the upstream end of the supply conduits. The other end of each supply conduit is connected to the respective compression stages CS1; CS2 and may be designated the downstream end of the supply conduits SC1; SC2. The two compression stages CS1; CS2 are connected in parallel. Hence, the compression outlet CPO1 of the first compression stage CS1 is connected directly to the common outlet CO and likewise, the compression outlet CPO2 of the second compression stage CS2 is also connected directly to the common outlet.

During a refueling of the receiving vessel RV, the first mobile gas supply vessel GSV1 and the second mobile gas supply vessel GSV2 is connected to the supply conduit arrangement to enable a fluid connection between the mobile gas supply and the supply conduits. The controller CTR then opens each of the two supply valves SV1; SV2 and further activates the compression stages CS1; CS2. Thereby, a separate parallel gas supply flow is established in each of the two supply conduits SC1 from the two respective mobile gas supply vessels to the respective compression stages CS1; CS2. The compression stages compress the gas and thus the first compression stage delivers compressed gas to the first compression outlet CPO1 and the second compression stage CS2 delivers compressed gas to the second compression outlet CPO2. The compressed gas in the two compression outlets is combined at the common outlet CO from which it is delivered to the receiving vessel RV.

In this embodiment, each compression stage is a separate diaphragm compressor. However, the compression arrangement may optionally be implemented using different types of compressors including a multistage compressor. In case a multistage compressor is utilized, the compression stage would be a compression stage of the multistage compressor.

Optionally, the controller may control the two compression stages to deliver substantially the same pressure at the first compression outlet CPO1 and the second compression outlet CPO2, respectively.

The controller may control the compression capacity of each of the two compression stages in a variety of ways as described in relation to the embodiment illustrated in FIG. 2. In this embodiment, the compression capacity is controlled by varying the speed of each of the compression stages. E.g., the controller may regulate the compressor speed, e.g., decreasing the speed (RPM) of the compressor to decrease the gas supply flow. However notice that other mentioned ways of regulating the compression stages may be implemented with the parallelly arranged compression stages as well.

FIG. 4 illustrates a supply conduit arrangement SCA and a compression arrangement CA according to an embodiment of the invention.

The supply conduit arrangement SCA comprises a first and a second supply conduit SC1; SC2 each having a supply valve SC1; SC2 and each fluidly connected to a separate compression stage CS1; CS2 of the compression arrangement CA at a downstream end, while the upstream end of each of the supply conduits can be connected to separate mobile gas supply vessels (not illustrated). Additionally, the supply conduit arrangement includes two interconnecting conduits IC1; IC2 that fluidly connects the first and the second supply conduits SC1; SC2 with one another. At one end, the first interconnecting conduit IC1 of the two interconnecting conduits is connected to the first supply conduit SC1 at the upstream side of the first supply valve SV1, while the other end is connected to the second supply conduit SC2 at a downstream side of the second supply valve SV2. A second interconnecting conduit IC2 of the two interconnecting conduits is connected to the second supply conduit SC2 at an upstream side of the second supply valve SV2 and connected to the first supply conduit SC2 at a downstream side of the first supply valve SV2. Each of the two interconnecting conduits IC1; IC2 comprises interconnecting valves IV1; IV2, which is controlled by a controller (not illustrated) between an open and a closed state.

By controlling the state of the interconnecting valves IC1; IC2 and the supply valves SV1; SV2, it is possible with this gas distribution arrangement to redistribute a gas supply flow received at the upstream end of any of the two supply conduits to any or both of the two compression stages. This may be advantageous in different situations. E.g., the compression stages may be individually configured and/or controlled and/or designed to perform most efficiently withing certain ranges, such as within, e.g., certain ranges of compression ratios and/or within certain ranges of inlet pressures, to mention a few non-limiting examples. Hence, the interconnecting conduits and/or another gas distribution arrangement may advantageously be utilized to direct a gas supply flow with a given pressure to the compression stage that operates most effectively at that particular pressure.

In a first example, both of the two supply valves SV1; SV2 are opened, while the two interconnecting valves IC1; IC2 are closed. This valve control distributes a gas supply flow received at each upstream end of the two supply conduits SC1; SC2 separately to a separate compression stage of the two compression stages CS1; CS2.

In a second example the controller (not illustrated) controls both supply valves to close, while controlling the two interconnecting valves IC1; IC2 to open. This valve control distributes a gas supply flow received at the upstream end of the first supply conduit SCI to the second compression stage CS2 via the first interconnecting conduit IC1. Simultaneously, a gas supply flow received at an upstream end of the second supply conduit SC2 is distributed to the first compression stage CS1 via the second interconnecting conduit IC2.

Notice that in principle, the interconnecting valves IC1; IC2 and the supply valves SV1; SV2 may be controlled in other ways than those stated in the two examples above.

Optionally, the supply conduit arrangement may be expanded to comprise more than two supply conduits. E.g., to increase the capacity of a high utility hydrogen refueling system comprising a hydrogen refueling station, it may be advantageous to be able to supply receiving vessels of that hydrogen refueling system with gas at a higher rate. Thereby, such hydrogen refueling system may comprise three, four, five or even further supply conduits, which may be connected to mobile gas supply vessels. Such station may advantageously also comprise more than two compression stages, and thereby, such station is capable of filling one or more receiving vessels with gas from more than two mobile gas supply vessels simultaneously, and thereby a higher filling rate may be achieved.

FIG. 5 illustrates a compression arrangement CA, a common outlet CO and a supply conduit arrangement SCA with cascade conduits CC, according to an embodiment of the invention.

The illustrated compression arrangement CA is similar to the arrangement illustrated in FIG. 1 and comprises two compression stages CS1; CS2. The supply conduit arrangement SCA is similar to the supply conduit arrangement illustrated in, e.g., FIG. 4. However, in addition to the supply conduit arrangement illustrated in FIG. 4, the supply conduit arrangement SCA illustrated in FIG. 5 comprises cascade conduits CC each having a cascade valve CV1; CV2. The cascade conduits connect CC the two supply conduits SC1; SC2 with the common outlet CO by bypassing the compression arrangement CA. The cascade valves CV1; CV2 is controlled by a controller (not illustrated). By opening the first cascade valve CVI of the two cascade valves, the gas supply flow in the first supply conduit is led to the common outlet via the cascade conduit CC and thereby the gas supply flow bypasses the compression arrangement CA. Similarly, when the second cascade valve CV2 of the two cascade valves are opened, a gas supply flow from the second supply conduit SC2 is led to the common outlet via the cascade conduit and by bypassing the compression arrangement CA.

The cascade valves can be used to bypass the compression arrangement CA, e.g., when the pressure in a mobile gas supply vessel (not illustrated) that feeds the supply conduit SC1; SC2 has a pressure that is higher than a receiving vessel (not illustrated) connected to the common outlet CO. Thereby, the pressure difference between the pressure in the mobile gas supply vessel and the receiving vessel is exploited to fill the receiving vessel and without using energy from the compression arrangement CA, which is advantageous.

In a first example of a filling of a receiving vessel, a first mobile gas supply vessel (not illustrated) is fluidly connected to a supply conduit SC1; while second mobile gas supply vessel (not illustrated) is connected to the other supply conduit SC2. Moreover, a receiving vessel (not illustrated) is connected to the common outlet. The pressure of the first mobile gas supply vessel is higher than the pressure in the receiving vessel and the pressure in the second mobile gas supply vessel. The pressure in the second mobile gas supply vessel is similar to the pressure in the receiving vessel. A controller (not illustrated) sets the first supply valve SV1, the second cascade valve CV2 and the interconnecting valves (IC1; IC2) to a closed state, while it controls the first cascade valve CV1 and the second supply valve SV2 to an open state. Thereby, a fluid connection is established from the first mobile gas supply vessel (not illustrated) to the receiving vessel (not illustrated) via the common outlet CO. Simultaneously, the control of the valves performed by the controller establishes a fluid connection from the second mobile gas supply vessel (not illustrated) to the receiving vessel (not illustrated) via the second supply conduit SC2, and at least the second compression stage of the compression arrangement. Thereby, the receiving vessel (not illustrated) is filled with gas provided by both of the mobile gas supply vessels (not illustrated). Specifically, the first mobile gas supply vessel provides gas to the receiving vessel via the cascade conduit CC and the common outlet, while gas from the second mobile gas supply vessel is pressurized by at least the second compression stage of the compression arrangement to fill the receiving vessel. During the filling of the receiving vessel one or more supply parameters may change. E.g., the pressure, temperature and state of charge of both the mobile gas supply vessels decrease, and also, the gas supply flow from the mobile gas supply vessels may decrease. These parameters could be obtained in various ways and, e.g., based on monitoring of the gas supply flow (including pressure, flow, temperature etc.) in the supply conduits SC1; SC2. In this example, a first supply parameter is pressure, and when the pressure in the first mobile gas supply vessel drops below a receiving vessel pressure threshold, and/or drops below a pressure difference threshold between the first mobile gas supply vessel and the receiving vessel, the controller closes the first cascade valve CV1 and opens the first supply valve 1. Thereby, redirecting the gas supply flow from the first mobile gas supply vessel to at least the first compression stage CS1 of the compression arrangement and therefrom to the receiving vessel via the common outlet. Thereby, filling of the receiving vessel from both of the mobile gas supply vessels can be continued even when the pressure in the first mobile gas supply vessel drops, e.g., drops below a pressure and/or comes close to the pressure in the receiving vessel.

Importantly, the compression arrangement CA and the supply conduit arrangement with cascade valves may be implemented with other embodiments of the invention.

Notice that one or more of the illustrated cascade conduits could be implemented with other embodiments of the invention, e.g., embodiments comprising additional mobile gas supply vessels, additional supply conduits and/or additional compression stages.

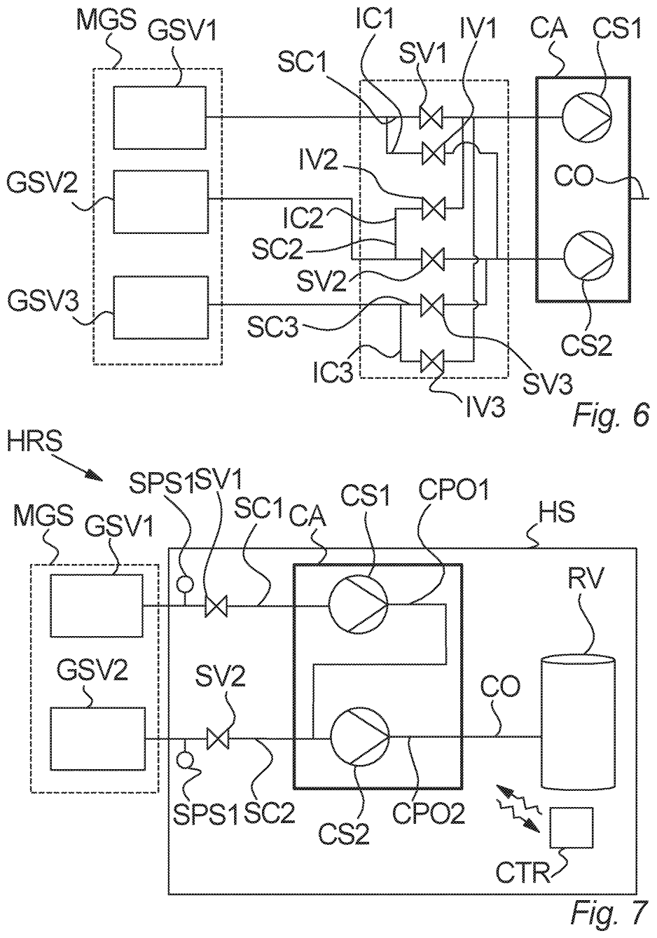

FIG. 6 illustrates a mobile gas supply MGS, a supply conduit arrangement SCA, a compression arrangement CA and a common outlet, according to an embodiment of the invention. The illustrated arrangements may be implemented with other embodiments of the invention, e.g., with the hydrogen refueling systems illustrated in FIG. 1, FIG. 2 and FIG. 3, respectively. The illustrated supply conduit arrangement SCA may, e.g., extend these mentioned embodiments of hydrogen refueling systems by enabling an additional connection of a third mobile gas supply vessel to the supply conduit arrangement, and furthermore by enabling redirection of flow from any of the mobile gas supply vessels to any compression stage using the interconnecting conduits IC1-IC3 and the supply conduits SC1-SC3.

More specifically, the compression arrangement CA illustrated in FIG. 6 is similar to the compression arrangement illustrated in., e.g., FIG. 4 and comprises two compression stages CS1, CS2. The supply conduit arrangement SCA is also comparable to that illustrated in FIG. 4, however, in addition to the two supply conduits SC1; SC2 with valves SV1; SV2 and the two interconnecting conduits IC1; IC2 with interconnecting valves IV1; IV2, the particular supply conduit arrangement illustrated in FIG. 6 comprises an additional supply conduit SC3 with a supply valve SV3, and an additional interconnecting conduit IC3 with an interconnecting valve IV3. Each of the three supply conduits are fluidly connected to a mobile gas supply vessel GSV1; GSV2; GSV3 of the mobile gas supply MGS. The valves and the compression arrangement may be controlled between an open and a closed state by a controller (not illustrated), such as, e.g., the controller illustrated in FIG. 1, FIG. 2, and FIG. 3.

When the arrangements illustrated in FIG. 6 is implemented with a hydrogen refueling system according to the invention, it is possible to enable a gas supply flow from three mobile gas supply vessels GS1-GS3 to one or more receiving vessels (not illustrated), via the compression arrangement and the common outlet. However, the arrangements of FIG. 6 may preferably be utilized to enable fast transition from filling from one mobile gas supply vessel to filling from another mobile gas supply vessel. E.g., when a common outlet is supplied with gas from the first and the second mobile gas supply vessel GS1; GS2 and one of the two gas supply vessels, e.g. the first mobile gas supply vessel GSV1 is substantially empty, a controller may fluidly disconnect the first mobile gas supply vessel from the supply arrangement by setting the first supply valve SV1 and the first interconnecting valve IV1 to a closed state. As an example, if the first mobile gas supply vessel GSV1 was fluidly disconnected from the first compression stage CS1, the controller opens the third interconnecting valve IC3, while keeping the third supply valve SV3 closed, to establish a fluid connection between the third mobile gas supply vessel GSV3 and the first compression stage CS1, Thereby, a fast and substantially seamless transition from supplying a gas supply flow from a one mobile gas supply vessel to establishing a mobile gas supply flow from another gas supply vessel may be achieved.

Advantageously, if a third mobile as supply vessel arrives at a hydrogen refueling system comprising the supply conduit arrangement illustrated in FIG. 6, while two other mobile gas supply vessels are already occupying two mobile gas supply vessels, the mobile gas supply vessel can be connected to the third free mobile gas supply vessel and thereby by valve control, the third mobile gas supply vessel can be quickly swapped with one of the two other mobile gas supply vessels. The swap may be performed when, e.g., one of the mobile gas supply vessels fluidly connected to the supply conduit arrangement is substantially empty.

Optionally, the supply conduit arrangement may be extended with additional supply conduits and interconnecting valves to enable connection of further mobile gas supply vessels. Likewise, the compression arrangement may optionally be extended with additional compression stages. This may advantageously increase the compression capacity of the compression arrangement.

FIG. 7 illustrates a hydrogen refueling system with supply parameters sensors, according to an embodiment of the invention. The hydrogen refueling system HRS is similar to the hydrogen refueling system illustrated in FIG. 2, except that the system illustrated in FIG. 7 comprises supply parameter sensors SPS. Hence the hydrogen refueling system is configured to fill a receiving vessel with gas simultaneously from two mobile gas supply vessels. Notice that this embodiment may be implemented using features and arrangement of other embodiments of the invention, e.g., including the supply conduit arrangement comprising interconnecting conduits illustrated in FIG. 4, the supply conduit arrangement comprising a cascade line as illustrated in FIG. 5, and the system illustrated in FIG. 6 that includes a mobile gas supply comprising an additional mobile gas supply vessel and a supply conduit arrangement configured to connect to that additional gas supply vessel.

More specifically, the hydrogen refueling system HRS illustrated in FIG. 7 comprises a mobile gas supply MGS with two mobile gas supply vessels GSV1; GSV2 separately coupled to a respective supply conduit SC1; SC2. Each supply conduit comprise a supply valve SV1; SV2 and a supply parameter sensor SPS1; SPS2. The system further comprises a compression arrangement CA with two compression stages CS1; CS2 coupled in serial, a common outlet CO coupled to a receiving vessel RV, and a controller CTR configured to receive supply parameters measurements from the supply parameter sensors SPS1; SPS2 and further configured for controlling the two compression stages CS1; CS2 and the state of the supply valves SV1; SV2 based on the received supply parameters.

The supply parameter sensors SPS is configured to measure a supply parameter. In this exemplified embodiment, the supply parameter sensor is a pressure sensor configured to measure a supply pressure. Each supply conduit SC1; SC2 comprises the pressure sensor, and hence, the pressure sensors provide a supply pressure for each of the supply conduits SC1; SC2. The supply pressure readings is transmitted to the controller.

In this embodiment a first mobile gas supply vessel GSV1 of the two mobile gas supply vessels has a pressure of 200 bar, while the second mobile gas supply vessel GSV2 has a pressure of 400 bar. To fill the receiving vessel RV with gas from the mobile gas supply MGS, both supply valves SV1; SV2 are controlled by the controller CTR to an open state. Thereby, a gas supply flow is established from the first mobile gas supply vessel GSV1 to the first compression stage CS1 via the first supply conduit SC1 of the two supply conduits SC1; SC2, and likewise a gas supply flow is established form the second mobile gas supply vessel GSV2 to the second compression stage CS2 via the second supply conduit SC2 of the two supply conduits SC1; SC2.

A first supply parameter sensors SPS1 of the two sensors SPS1; SPS2 measures a supply pressure of substantially 200 bar in the first supply conduit SC1. A second supply sensor of the two sensors SPS1; SPS2 measures a supply pressure of substantially 400 bar in the second supply conduit SC2. The controller receives both of these supply pressure readings from the two sensors SPS1; SPS2, and based on these supply pressures, the controller operates the first compression stage to provide a pressure at the compression outlet that is substantially identical to the supply pressure measured in the second supply conduit SC2, which in this example is substantially 400 bar. Thereby, the first compression stage delivers compressed gas at a pressure of substantially 400 bar from the first mobile gas supply GSV1 to the inlet of the second compression stage CS2. Moreover, the second compression stage CS2 is supplied with gas from the second mobile gas supply GSV2 via the second supply conduit SC2. The second compression stage receives the stream of gas from both the first compression stage CS1 and from the second supply conduit and compresses the gas to deliver compressed gas to the receiving vessel via the common outlet. The second compression stage is controlled by the compressor to fill the receiving vessel with the gas to a pressure of substantially 500 bar.

Optionally, the hydrogen refueling system may comprise two temperature sensors. Each respective temperature sensor may optionally be arranged to measure a representation of a supply temperature of a gas supply flow in one of the respective supply conduits SC1; SC2.

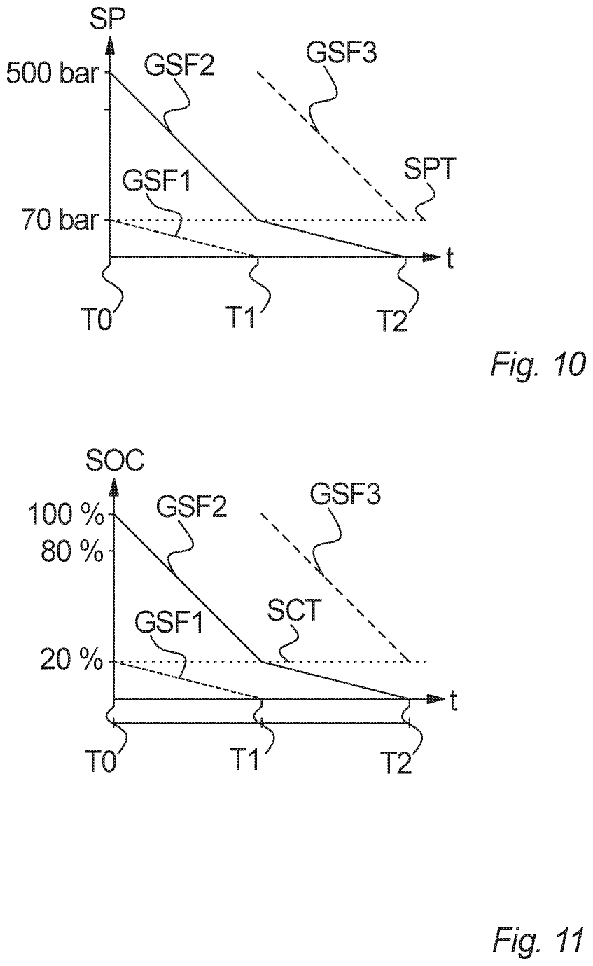

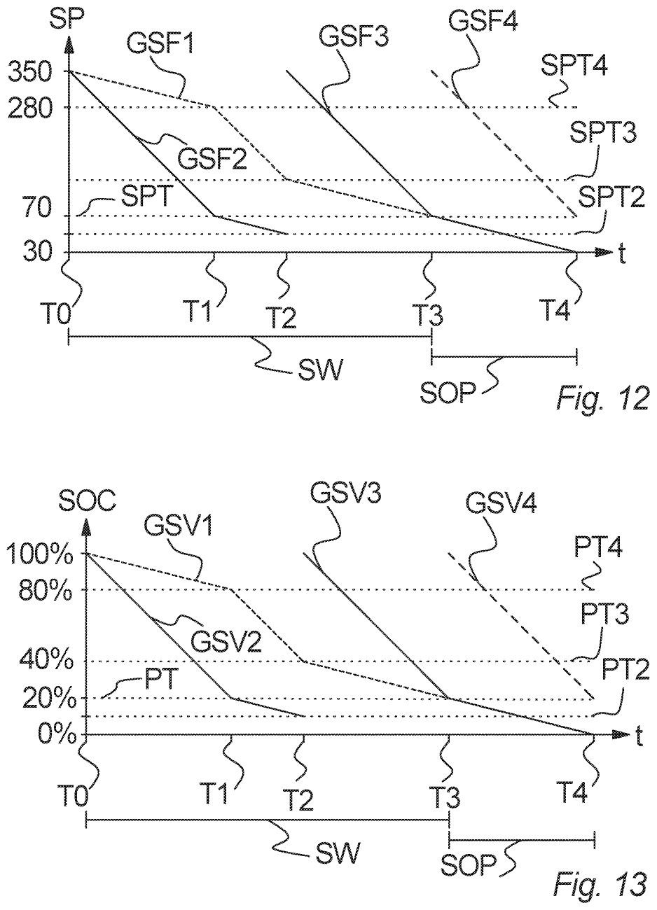

Optionally, the hydrogen refueling station may be controlled by the controller according to various control strategies (sometimes also referred to as control schemes), such as, e.g., the control strategies illustrated in FIG. 10, FIG. 11, FIG. 12 and FIG. 13.

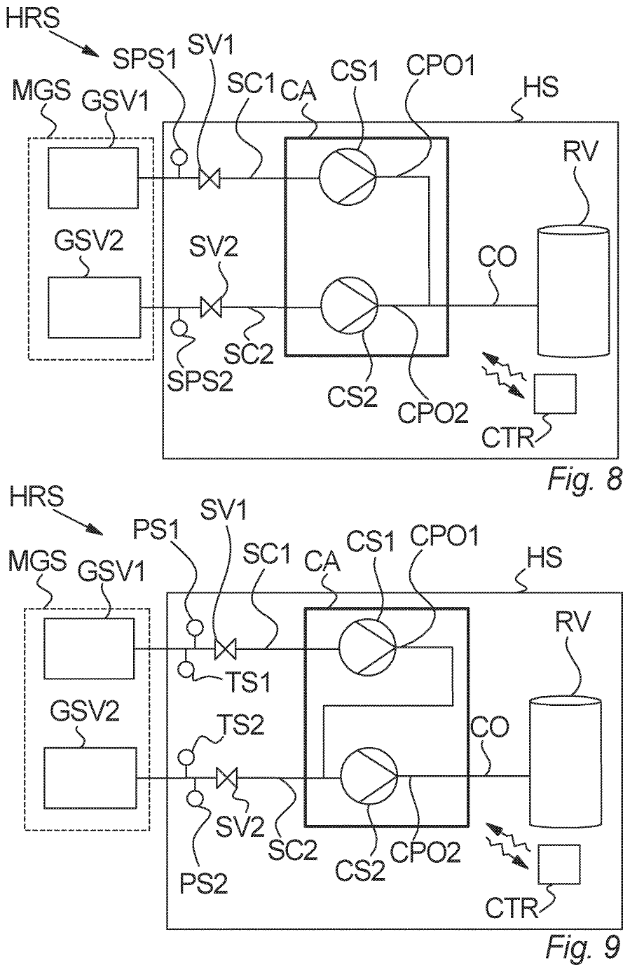

FIG. 8 illustrates a hydrogen refueling system HRS with supply parameters sensors SPS, according to an embodiment of the invention. The hydrogen refueling system HRS is similar to the hydrogen refueling system illustrated in FIG. 3, except that the hydrogen refueling system illustrated in FIG. 8 comprises supply parameter sensors SPS1; SPS2. Hence, similar to other embodiments, the hydrogen refueling system HRS is configured to fill a receiving vessel with gas simultaneously from two mobile gas supply vessels. Notice that this embodiment may be implemented using features and arrangement of other embodiments of the invention, e.g., including the supply conduit arrangement comprising interconnecting conduits illustrated in FIG. 4, the supply conduit arrangement comprising a cascade line as illustrated in FIG. 5, and the system illustrated in FIG. 6 that includes a mobile gas supply comprising an additional mobile gas supply vessel and a supply conduit arrangement configured to connect to that additional gas supply vessel.

The supply parameter sensors SPS1; SPS2 is configured to measure a supply parameter. In this exemplified embodiment, the supply parameter sensors SPS1; SPS2 are pressure sensors configured to measure a supply pressure. Each of the two supply conduits SC1; SC2 each comprises one of the pressure sensors, and hence, the pressure sensors provide a supply pressure for each of the supply conduits SC1; SC2. The supply pressure readings are transmitted to the controller CTR.

In this embodiment, the mobile gas supply MGS comprises two mobile gas supply vessels GSV1 and GSV2, which in this embodiment is tube trailers comprising hydrogen gas. The first mobile gas supply vessel GSV1 of the two mobile gas supply vessels has a pressure of 70 bar, while the second mobile gas supply vessel GSV2 has a pressure of 450 bar. The first mobile gas supply vessel GSV1 has already been emptied to a state of charge much below 50 percent, while the second mobile supply vessel GSV2 has a state of charge of substantially 100 percent and has just been connected to the supply conduit SC2. To fill the receiving vessel RV with gas from both mobile gas supply vessels simultaneously, each of the two gas supply vessels GSV1; GSV2 are fluidly connected to separate supply vessels SV1; SV2, and both of the supply valves SV1; SV2 are controlled by the controller CTR to an open state. Thereby, a gas supply flow is established from the first mobile gas supply vessel GSV1 to the first compression stage CS1 via the first supply conduit SC1 of the two supply conduits SC1; SC2, and likewise a gas supply flow is established form the second mobile gas supply vessel GSV2 to the second compression stage CS2 via the second supply conduit SC2 of the two supply conduits SC1; SC2.

The first supply parameter sensors SPS1 of the two sensors SPS1; SPS2 measures a supply pressure in the first supply conduit SC1 of substantially 70 bar corresponding substantially to the pressure of the first mobile gas supply vessel GSV1. A second supply sensor of the two sensors SPS1; SPS2 measures a supply pressure of substantially 450 bar in the second supply conduit SC2, corresponding substantially to the pressure in the second mobile gas supply vessel GSV2. The supply pressure measurements are transmitted to the controller via a wired connection. However, other embodiments may utilize wireless transmission of the sensor readings. The controller receives both of the supply pressure readings from the two sensors SPS1; SPS2, and based on these supply pressures, the controller operates the two compression stages CS; CS2 to provide a substantially equal outlet pressure at each compression outlet CPO1; CPO2. In this example, the second compression stage is provided with an initial inlet pressure of substantially 450 bar, and the controller operates the compression stage CS2 to fill the receiving vessel with hydrogen to reach a pressure of 500 bar in the receiving vessel. The first compression stage CS1 is provided with an initial inlet pressure of 70 bar, and the controller operates the first compression stage CS1 to provide an outlet pressure that is substantially identical to the outlet pressure provided by the second compression stage CS2. Thereby, in this example, the compression ratio of the first compression stage CS1 is higher than the compression ratio of the second compression stage CS2. The two compression outlets CPO1; and CPO2 is both connected directly to the common outlet CO though which the compressed gaseous hydrogen is delivered to the receiving vessel RV.

Notice that during the filling, the pressure drop occurring in both the mobile gas supply vessels GSV1; GSV2 results in an associated reduction in temperature in the mobile gas supply vessels and in, e.g., the supply conduits SC1; SC2. To avoid reaching critically low temperatures at which the filling would need to be halted, the flow rate at which each mobile gas supply vessel is emptied at is regulated by the controller based on the measured supply pressures and based on a first supply parameter threshold, which in this example is a first supply pressure threshold. In this example, the controller controls the speed of the first compression stage CS1 to be lower than the speed of the second compression stage CS2. Thereby, the first gas supply vessel is emptied at a lower flow rate compared to the second gas supply vessel GSV2 and hence, the gas supply flow in the first supply conduit SC1 is smaller than the gas supply flow in the second supply conduit SC2. The controller receives supply pressure readings from both pressure sensors during the filling of the receiving vessel, and when the supply pressure in one of the two supply conduits SC1 SC2, as measured by the pressure sensors SPS1; SPS2, reaches the first pressure threshold, the controller establishes a first flow reduction in the particular supply conduit wherein the supply pressure has crossed the first supply pressure threshold. In this example, the first supply pressure threshold is 70 bar and the flow reduction of the gas supply flow is 65 percent, meaning that the flow is reduced by 65 percent when the supply pressure reaches or crosses 70 bar. The flow reduction is established in the first supply conduit first, since in in this example, the supply pressure would drop below the first supply pressure threshold first because the first gas supply vessel GSV1 has a much lower pressure of 70 bar compared to the second mobile gas supply vessel GSV2 that has a pressure of 450 bar. The reduction of 65 percent of the gas supply flow from the firs mobile gas supply vessel GSV1 is established by the controller, which reduces the speed of the first compression stage. The flow reduction causes a reduction in the rate at which the pressure is reduced and hence a reduction in the rate at which the temperature is reduces in the first mobile gas supply vessel GSV1, and hence ensures that filling of the receiving vessel with gas from the first mobile gas supply vessel GSV1 can be continued, since critically low temperatures are avoided.

At some point, the first gas supply vessel is substantially empty and the gas supply flow from the first gas supply vessel GSV1 is terminated. At this point, the first gas supply vessel GSV1 is disconnected from the first supply conduit to enable another gas supply vessel containing gas to be connected to the first supply conduit in order to continue filling of the receiving vessel RV. The empty state of a mobile gas supply vessel is determined by a second supply parameter threshold. In this exemplified embodiment, the second supply parameter threshold is a second supply pressure threshold of 30 bar. Thereby, the controller terminates the gas supply flow by closing the supply valve when the supply pressure in the corresponding supply conduit reaches below 30 bar. In this example, the supply pressure in the first supply conduit crosses 30 bar when the supply pressure in the second supply conduit is substantially just below 70 bar. Hence the gas supply flow from the second mobile gas supply vessel GSV2 is reduced by 65 percent since the supply pressure in that supply conduit has crossed the first supply pressure threshold, and at the same time, based on input from the pressure sensor of the first supply conduit SC1, the controller closes the first supply valve SV1. The first mobile gas supply vessel is then fluidly disconnected from the first supply conduit, and a third mobile gas supply vessel containing pressurized hydrogen may then be connected to the first supply conduit SC1. The third mobile gas supply vessel (not illustrated) contains pressurized hydrogen at 500 bar, and the temperature in the third mobile gas supply vessel is well above critically low temperature levels, and hence, the third mobile gas supply vessel may provide a larger gas supply flow compared to the reduced flow from the second mobile gas supply vessel GSV2, which is below the first supply pressure threshold of 70 bar. However, the simultaneous flow from the two mobile gas supply vessels enables a higher filling rate of the receiving vessel compared to what could be achieved by filling from a single mobile gas supply vessel, e.g., because the temperature of the mobile gas supply may be managed above critically low temperature levels.

Notice that the above-described cycle of reducing gas supply flow according to supply pressure and swapping an empty mobile gas supply vessel with a mobile gas supply vessel containing more gas may be continued, and thereby providing continuous supply of gas to a hydrogen refueling station, such as e.g. a hydrogen refueling station.

Notice that during the filling of the receiving vessel the pressure in both of the two mobile gas supply vessels GSV1; GSV2 decreases gradually, and hence, to avoid reducing the filling rate, the compression stages may optionally be operated to counter balance the pressure drop. This may be achieved in various ways, including, e.g., by increasing the speed of the compression stages, by increasing the stroke volume of the compression stages etc.

Notice that the described flow reduction and/or flow control of the gas supply flow according to a supply pressure threshold may be implemented with other embodiments of the invention comprising one or more pressure sensors, e.g., including embodiments comprising serially coupled compression stages, such as the embodiment illustrated in FIG. 7.

Further notice that the described termination of gas supply flow according to a second supply pressure threshold and/or the swapping of an empty mobile gas supply vessel with another mobile gas supply vessel containing pressurized gas may also be implemented with embodiments comprising the serially coupled compression stages, e.g., the embodiment illustrated in FIG. 7.

Optionally, when two mobile gas supply vessels, the controller may control the speed of one compression stage to be lower compared to the speed of the other compression stage. When a supply pressure associated with a supply conduit reaches a first supply pressure threshold, the gas supply flow in that supply vessel may be reduced, while the gas supply flow in the other mobile gas supply vessel may be increased. The increase may correspond to the flow reduction established in the supply conduit associated with the supply pressure that crossed the first supply pressure threshold. Advantageously, this may have the effect that the temperature in the mobile gas supply vessels do not reaches a critically low level, while at the same time, the simultaneous gas supply flow to the receiving vessel provided by both of the two mobile gas supply vessels are maintained at a relatively stable rate.

FIG. 9 illustrates a hydrogen refueling system HRS with temperature and pressure sensors, according to an embodiment of the invention. The hydrogen refueling system HRS is similar to the hydrogen refueling system illustrated in FIG. 7, except that it comprises additional supply parameter sensors in form of temperature sensors. Similar to other embodiments, the hydrogen refueling system HRS is configured to fill a receiving vessel with gas simultaneously from two mobile gas supply vessels. Notice that this embodiment may be implemented using features and arrangement of other embodiments of the invention, e.g., including the supply conduit arrangement comprising interconnecting conduits illustrated in FIG. 4, the supply conduit arrangement comprising a cascade line as illustrated in FIG. 5, and the system illustrated in FIG. 6 that includes a mobile gas supply comprising an additional mobile gas supply vessel and a supply conduit arrangement configured to connect that additional gas supply vessel with a compression arrangement.

More specifically, the hydrogen refueling system comprises a mobile gas supply comprising a first gas supply vessel GSV1 and a second mobile gas supply vessel GSV, each fluidly connected to separate supply conduits SC1; SC2 of a supply conduit arrangement SCA. Each supply conduit SC1; SC2 comprises a temperature sensor TS1; TS2 configured to measure supply temperature, and a pressure sensor PS1; PS2 configured to measure supply pressure. The supply conduits SC1; SC2 are each connected separately to a compression stage CS1; CS2 of a compression arrangement, which is a multistage compressor comprising the two compression stages CS1; CS2. The compression outlet CPO1 of a first compression stage CS1 of the two compression stages are fluidly connected to the inlet of the second compression stage CS2, and the compression outlet of the second compression arrangement is fluidly connected to a receiving vessel RV via a common outlet CO. A controller CTR is configured to receive measurements from the temperature and pressure sensors and to control the supply valves and the compression arrangement based on the received temperature and pressure measurements.

Furthermore, the controller is configured to establish a reduction in a gas supply flow from a mobile gas supply vessel when a supply pressure associated with that mobile gas supply vessel and measured with a pressure sensor PS1; PS2 crosses below a first supply pressure threshold. In this embodiment, the supply pressure threshold is 70 bar and the established flow reduction is a 65 percent.

Additionally, the controller is configured to establish a reduction in a gas supply flow from a mobile gas supply vessel when a supply temperature associated with that mobile gas supply vessel and measured with a temperature sensor TS1; TS2 crosses below a first supply temperature threshold. In this embodiment, the first supply temperature threshold is minus 30 degrees Celsius and the associated flow reduction that is established is a reduction of 65 percent.

Optionally, the controller may be configured to increase a flow rate of a gas supply flow from one gas supply vessel, when another gas supply flow from another gas supply vessel is reduced. E.g., if the controller establishes a flow reduction in a gas supply flow from the first mobile gas supply vessel GSV1, e.g., based on the supply pressure falling below the first supply pressure threshold and/or based on the supply temperature falling below the first supply temperature threshold, the controller may increase the gas supply flow from the second mobile gas supply vessel GSV2, The increase in gas supply flow from one gas supply vessel, e.g. the second gas supply vessel, may optionally correspond to the reduction in gas supply flow established in, e.g., the first gas supply vessel GSV1. Thereby, the total gas supply flow from the mobile gas supply may remain substantially unchanged. Notice, that the increase the controller is configured to only increase a gas supply flow if the supply pressure and the supply temperature threshold associated with the gas supply flow is above the first supply pressure threshold and the first supply temperature threshold, respectively.

Moreover, the controller is configured to terminate a gas supply flow from a mobile gas supply vessel when a supply temperature associated with that mobile gas supply vessel and measured with a temperature sensor falls below a safety temperature threshold. In this embodiment, the safety temperature threshold is minus 40 degrees Celsius. Terminating the flow have the effect that it protects components of the hydrogen refueling system, including the mobile gas supply vessel from getting event colder and thereby, this may minimize the risk of component damage and/or minimize component wear.

FIG. 10 illustrates a representation of pressure-based control of gas supply flows GSF1-GSF3 each coming from a different gas supply vessel and flowing toward a different compression stage and therefrom the to a receiving vessel via a common outlet, according to an embodiment of the invention. The illustrated flow control strategy may be implemented on various hydrogen refueling systems of the invention, including, e.g., the hydrogen refueling systems illustrated in FIG. 7, FIG. 8, and FIG. 9. The illustrated flow control may be part of a flow control strategy comprising a swing in period such as the flow control strategies illustrated in FIG. 12 and FIG. 13, in which case the flow control strategy may be implemented during a standard operation period, which typically follows a swing in period, as described in relation to FIG. 12 and FIG. 13. The flow control illustrated in FIG. 10 may be controlled by one or more controller(s) comprised by the various embodiments of hydrogen refueling systems, according to various embodiments of the invention. The mentioned one or more controllers may perform the flow control by operating different valves and compression stages of a hydrogen refueling station according to embodiments of the invention. The supply pressure SP may be measured using pressure sensors positioned in, e.g., supply conduits, as described in relation to various embodiments of the hydrogen refueling system.

More specifically, FIG. 10 illustrates a representation of a supply pressure SP for different gas supply flows GSF1-GSF3 over time t, during filling of a receiving vessel. The gas supply flows are regulated according to a first supply pressure threshold SPT. In this example, the supply pressure threshold is a pressure supply pressure of 70 bar.

In this example, the first gas supply flow GSF1 is represents a flow of gas in a supply conduit. The first gas supply flow GF1 streams towards a compression arrangement from a first gas supply vessel, which have already been emptied to a pressure just below 70 bar. The second gas supply flow GSF2 and the third gas supply flow GSF3 represents gas supply flows in a second and a third supply conduit, respectively. These two gas supply flows GSF2; GSF3 are established from a second mobile gas supply vessel and from a third mobile gas supply vessel, respectively, which both is both at a state of charge of approximately 100 percent, corresponding to a supply pressure of 500 bar, in this example. The gas supply flows GSF1-GSF3 are controlled according to a first supply parameter threshold, which in this example is a supply pressure threshold SPT of 70 bar.

At time T0 the first gas supply flow GSF1 is established from the first mobile gas supply vessel to a first compression stage via a first supply conduit and likewise, the second gas supply flow GSF2 is established from a second gas supply vessel to a second compression stage via a second supply conduit. The first gas supply flow GSF1 and the second gas supply flow GSF2 are combined to a common flow (not illustrated) and led to a receiving vessel via a common outlet, as described in relation to various embodiments of the invention. The supply pressure SP associated with the first gas supply flow GSF1 is just below 70. The pressure of the second gas supply flow GSF2 is substantially 500 bar, which corresponds to the pressure of the second mobile gas supply vessel.

During the time period from time T0 to time T1, the supply pressure SP of both gas supply flows GSF1; GSF2 is decreasing as more and more gas is transferred from the first and the second mobile gas supply vessels to the receiving vessel. Notice that the rate of change in supply pressure indicated by the slope differs between the two gas supply flows. The first gas supply flow is controlled according to its supply pressure, which is below 70 bar and thereby below the first supply pressure threshold SPT. Because the first gas supply flow GSF1 is below the supply pressure threshold SPT of 70 bar, the controller has already established a reduction of the flow rate of the first gas supply flow GSF1. In this example, the flow rate is reduced by 65% of the initial flow rate of the first gas supply flow when a gas supply flow falls below the supply pressure SPT of 70 bar. Meanwhile, the second gas supply flow GSF2 having a supply pressure of 500 bar is controlled according to its supply pressure being above the supply pressure threshold of 70 bar. Hence, the controller has not initiated any flow reduction for the second gas supply flow GSF2, which is thereby substantially larger than the second gas supply flow in the period from T0 to T1. The difference in flow rate can be observed by the difference in the slope of the curves, as the slope of each curve represents the pressure drop, which is closely related to the flow rate, and hence, the total gas supply flow from the gas supply to the receiving vessel is given by the sum of the gas supply flows. Advantageously, by filling from two mobile gas supply vessels in parallel via two separate gas supply flows, the total gas supply flow may be larger compared to the situation where filling of the receiving vessel is performed from only one gas supply vessel.

At time T1, the first gas supply flow reaches a second supply pressure threshold, which indicate that the first mobile gas supply vessel is substantially empty. In this example the second gas supply pressure is 31 bar. As the supply pressure SP of the first gas supply flow has fallen below 30 bar at time T1, the first gas supply flow is terminated. To sustain the total gas supply flow to the receiving vessel, a third gas supply flow GSF3 is established from a third mobile gas supply vessel having a pressure of substantially 500 bar at T1. The supply flow SP of the third gas supply flow is thereby substantially 500 bar, and hence the third gas supply flow is controlled according to having a supply pressure above the first supply pressure threshold SPT, which means that no flow reduction is applied for the third gas supply flow from time T1 to T2. Meanwhile, at T1 the supply pressure SP of the second gas supply flow GSF2 falls below the first supply pressure threshold of 70 bar. Thereby, the controller establishes a flow reduction, which reduces the second gas supply flow GSF2 by 65 percent. This can be observed by the reduction in the slope from T1 to T2 for the second gas supply flow GSF2. The flow reduction is established to ensure that the temperature of, e.g., the mobile gas supply vessels providing the gas does not fall below critically low levels, which would otherwise require a complete termination of the gas supply flow form that mobile gas supply vessels.

Optionally, to avoid reaching critically low temperature levels in, e.g., mobile gas supply vessels during filling of a receiving vessel, the controller may establish a first flow reduction of a gas supply flow when the supply temperature of that gas supply flow reaches a first temperature threshold. The supply flow reduction may be a reduction of the flow rate of 65 percent. The supply temperature may, e.g., be a temperature of minus 30 degrees Celsius.

Optionally, a gas supply flow from a mobile gas supply vessel may be terminated when a supply temperature of a gas supply flow from that mobile gas supply vessel falls below a safety temperature threshold. The safety temperature threshold may, e.g., be minus 40 degrees Celsius.

Notice that the swap of the mobile second gas supply vessel with the third mobile gas supply vessel at time T1 may be performed in various ways. E.g., the third gas supply vessel may be connected to the same supply conduit that the second supply conduit was connected to, however, it may also be connected to a different supply conduit.

In this exemplified embodiment illustrating a flow control strategy for filling a receiving vessel, the receiving vessel was filled with gas from two simultaneous gas supply flows from two separate gas supply vessels. However, the principles of the illustrated control strategy may optionally be applied to fill one or even more receiving vessels with gas from more than two gas supply vessels simultaneously. E.g., from three, four or five gas supply vessels simultaneously. As described elsewhere, this may require a refueling system comprising a corresponding number of gas supply conduits and compression arrangement.

Optionally, this flow standard operation flow control strategy may be preceded by a swing in flow control strategy such as illustrated in, e.g., FIG. 12 or 13.

FIG. 11 illustrates a representation of a flow control strategy based on state of charge, according to an embodiment of the invention. The illustrated flow control follows similar principles as the flow control strategy illustrated in FIG. 10, and hence, the flow control strategy describes filling a receiving vessel with gas from two simultaneous gas supply flows from two separate mobile gas supply vessels (not illustrated). The illustrated flow control may be implemented on various hydrogen refueling systems of the invention. E.g., the hydrogen refueling system illustrated in FIG. 9. The illustrated flow control may, e.g., optionally be implemented during a standard operation period, which may follow a swing in period, as illustrated in FIG. 12 and in FIG. 13. The illustrated flow control may be controlled by one or more controller(s) comprised by the various embodiments of hydrogen refueling systems, according to various embodiments of the invention. The mentioned one or more controllers may perform the flow control by operating different valves and compression stages of a hydrogen refueling station according to embodiments of the invention. The state of charge SOC may be determined based on pressure and temperature measurements from pressure and temperature sensors positioned in, e.g., supply conduits or elsewhere, as described in relation to various embodiments of the hydrogen refueling system, such as, e.g., the system illustrated in FIG. 9. The temperature and pressure sensors could also be placed elsewhere, e.g., the sensors could be part of the mobile gas supply vessels.

More specifically, FIG. 11 illustrates a representation of a state of charge SOC over time for different gas supply flows GSF1-GSF3, during filling of a receiving vessel. The gas supply flows are regulated according to a first state of charge threshold SCT. In this example, the state of charge threshold SCT is a state of charge of 20 percent. The state of charge refers to a state of charge of a mobile gas supply vessel that delivers the gas of the illustrated gas supply flows GSF1-GSF3. Regulation according to state of charge may refer to one or more state of charge being determined, and then the flow rate of the gas supply flows is regulated according to the determined one or more state of charge. Typically, the active regulation is done when the determined stat of charge crosses a state of charge threshold.

At time T0, a first mobile gas supply vessel and a second gas supply vessel is fluidly connected to a hydrogen refueling station to fill a receiving vessel with gas. In this example the gas is gaseous hydrogen. A first gas supply flow GSF1 is established from the first gas supply vessel with a state of charge of 20%, while a second gas supply flow GSF2 is established from the second gas supply vessel having a state of charge of substantially 100%. The flow rate of the gas supply flows is correlated with the pressure drop, which is represented by the slope of the illustrated curves. Hence, by observing the slopes of the two gas supply flows, it can be realized that the flow rate of the first gas supply flow GSF1 is lower than the flow rate of the second gas supply flow GSF2 from time T0 to time T1. As the first mobile gas supply vessel has fallen below 20% state of charge, which is the first state of charge threshold SCT, the flow rate of the first gas supply flow GSF1 is reduced by 65 percent. On the contrary, the second gas supply vessel has a state of charge above 100 percent at T0, and hence, the second gas supply flow GSF2 is not reduced from time T0 to T1.

At time T1, the second mobile gas supply vessel has reached 20 percent state of charge SOC, and as it crosses 20 percent SOC shortly after T1, the second gas supply flow GSF2 is reduced by 65 percent. Meanwhile, the first gas supply vessel is substantially empty, and hence the first gas supply flow GSF1 is terminated. Upon termination of the first gas supply flow GSF1, a third mobile gas supply flow GSF3 is established from a third gas supply vessel having a state of charge of substantially 100 percent initially. Thereby, the filling of the receiving vessel is continued with a reduced second gas supply flow GSF2 and with a third gas supply flow GSF3 that has not been reduced, since the state of charge of the third gas supply vessel is above the first state of charge threshold.

Notice that the flow control based on state of charge may be combined with flow regulations based on other parameters. E.g., based on supply temperature measurements and an associated first supply temperature threshold and optionally a safety temperature threshold.

Optionally, the principles of the control strategy may be applied to control filling of a one or more receiving vessels form additional gas supply flows from additional mobile gas supply vessels. E.g., three, such as a four, such as a five, such as six additional mobile gas supply vessels.

Optionally, the empty state of a mobile gas supply vessel may be defined by a second supply parameter threshold. When the second supply parameter threshold is crossed, the gas supply flow is terminated, and optionally, another gas supply vessel may be connected to fill a receiving vessel. In the above example related to the flow control illustrated in FIG. 11, the state of charge threshold may, e.g., be substantially 0 percent. In this case state of charge may refer to a useable state of charge of, e.g., 0 percent meaning that a small amount of gas may be left in the gas supply vessel.

Optionally, this standard operation flow control strategy may be preceded by a swing in flow control strategy such as illustrated in, e.g., FIG. 12 or 13.

FIG. 12 illustrates a representation of a flow control strategy comprising a swing in strategy performed during a swing in period SW, according to an embodiment of the invention. The illustrated flow control strategy is based on supply pressure readings and supply pressure thresholds SP1-SP4. In this exemplified embodiment, the illustrated swing in period SW is performed before a standard operation flow control strategy, which is performed during a standard operation period SOP. The swing in strategy may, e.g., be useful when two mobile gas supply vessels that initially have the same pressure are connected to a hydrogen refueling station of the invention, to fill a receiving vessel. Based on the swing in period, the two mobile gas supply vessels is emptied at different flow rates.

The standard operation period of the illustrated flow control strategy follows similar principles as the flow control strategy illustrated in e.g., FIG. 10, while providing an additional swing in strategy. Similar to other exemplified flow control strategies of the invention, the flow control strategy illustrated in FIG. 12 provides a flow control strategy for filling a receiving vessel with gas from two simultaneous gas supply flows from two separate mobile gas supply vessels (not illustrated). The illustrated flow control may be implemented on various hydrogen refueling systems of the invention. E.g., the hydrogen refueling systems illustrated in FIG. 8 and FIG. 9. The illustrated flow control may be controlled by one or more controller(s) comprised by the various embodiments of hydrogen refueling systems, according to various embodiments of the invention. The mentioned one or more controllers may perform the flow control by operating different valves and compression stages of a hydrogen refueling station according to embodiments of the invention.

More specifically, FIG. 11 illustrates a representation of supply pressure SP as a function of time t over a swing in period SW and a standard operation period SOP for four different gas supply flows GSF1-GSF4 from four respective mobile gas supply vessels (not illustrated), and wherein the gas supply flows GSF1-GSF4 provides gas from the respective mobile gas supply vessels to one or more receiving vessels via a compression arrangement. In this embodiment, only two mobile gas supply vessels are delivering gas to the receiving vessel simultaneously. In this example, each of the mobile gas supply vessels have an initial pressure of 350 bar corresponding to a supply pressure of substantially 350 bar, before the pressure drops as the mobile gas supplies are emptied.

At beginning of the swing in period at time T0, a first gas supply flow GSF1 with a supply pressure of 350 is established from a first mobile gas supply vessel, and a second gas supply flow with a supply pressure of 350 bar is established from a second mobile gas supply vessel. The gas supply flows supply gas to a receiving vessel, typically via a compression arrangement and/or via a cascade conduit as described elsewhere. From time T0 to time T1, the first gas supply flow GSF1 is limited to a flow rate approximately 65% smaller than the flow rate of the second gas supply flow GSF2. This can be realized by comparing the slopes of the two-gas supply flow, since the slopes indicate the pressure drop over time, which is correlate to the flow rate. E.g., the steeper slope of the second gas supply flow GSF2 corresponds to a larger flow rate compared to the relatively less steep slope of the first gas supply flow GSF1.

At time T1, the supply pressure SP of the first gas supply flow GSF1 falls below a fourth supply pressure threshold SPT4, which is 280 bar. This triggers an increase in flow rate of 65 percent, and hence, the flow rate of the first gas supply flow GSF1 now corresponds to the flow rate of the second gas supply flow during the period from T0 to T1. Meanwhile, the second gas supply flow GSF2 falls below a first supply pressure threshold SPT of 70 bar at time T1 and thereby triggers a flow reduction of 65 percent, and thus, the flow rate of the second gas supply flow GSF2 now corresponds to the flow rate of the first gas supply flow GSF1 as it was from time T0 to time T1. By regulating the flow rate in this way, the total sum of the two flow rates remains substantially unchanged, while the pressure drop of the two gas supply flows are varied. The variation in supply pressure for each gas supply flow ensures that the supply temperature of a gas supply flow or of a mobile gas supply vessel does not fall below a safety temperature threshold at which the gas supply flow would need to be halted or falls to a first temperature threshold, at which the flow rate would need to be reduced as a precautionary step to avoid reaching the safety temperature threshold.

At time T2, the second gas supply GSF2 reaches a second supply pressure threshold SPT2, which in this embodiment is 50 bar. This triggers a termination of the second gas supply flow GSF2. At this point the second mobile gas supply vessel can be disconnected to leave room for another gas supply vessel comprising more gas. This could typically a mobile gas supply vessel with a state of charge close to 100 percent. At substantially the same time, the first gas supply flow falls below a third supply pressure threshold SPT3, which in this example is 110 bar. This triggers a 65 percent reduction the flow rate of the first gas supply flow GSF1. To keep the total gas supply flow substantially constant, a third gas supply flow GSF3 from a third mobile gas supply vessel is established with a gas supply flow that is substantially 65% larger than the flow rate of the first gas supply flow GSF1 from time T2 to time T3.

Time T3 marks the beginning of a standard operation period SOP of the flow control strategy. The swing in period ensured that the first and the second mobile gas supply vessels were emptied at different timepoints and thereby swapping of empty mobile gas supply vessels with new full mobile gas supply vessels are offset. Thereby, ensuring that at least one mobile gas supply vessel may be connected to the hydrogen refueling station to supply gas to a receiving vessel. The flow control during the standard operation period SOP ensure that this offset is maintained. Furthermore, the flow control strategy of the standard operation period regulates the gas supply flows such that the flow rate is largest for gas supply flows having the larges supply pressure SP. Advantageously, this minimizes the overall energy consumption from, e.g., the compression stages.

At time T3, the third gas supply flow GSF3 reaches the first supply pressure threshold SPT, which is 70 bar. This triggers a flow reduction of the third gas supply flow of 65%. Meanwhile, the first gas supply flow GSF1 is terminated and instead a fourth gas supply flow GSF4 is established from a fourth mobile gas supply vessel. The fourth gas supply flow GSF4 has a pressure that is substantially equal to the gas supply flow of the third gas supply flow from time T2 to time T3. From time T3 to time T4, the third gas supply vessel is thereby emptied at a flow slow rate, while the fourth gas supply vessel is emptied at a relatively larger flow rate. AT time T4, the third mobile gas supply vessel is at an empty state at 30 bar, and the third gas supply flow is terminated. The standard operation strategy may be performed continuously to continuously supply gas to a receiving vessel. Notice that during the standard operation period SOP, again the sum of the two flows is kept substantially constant, while at the same time, the variation in flow rate or correspondingly pressure drop, ensures that the temperature does not fall to critically low temperature levels.

The flow control strategy of the standard operation period may vary depending on the particular implementation of the invention. In this exemplified control strategy, the standard operation strategy is similar to the flow control strategy illustrated in FIG. 10.

Notice that while the drop in supply pressure over time of the gas supply flows GSF1-GSF4 is linear in this exemplified flow control strategy, the drop in supply pressure may be non-linear in other embodiments of the invention. Furthermore, the slope of the supply pressure of the gas supply flows GSF1-GSF4 are proportional to the flow rate of the gas supply flows GSF1-GSF4. Hence, the illustrated changes in the slope of each gas supply flow indicate a change in flow rate. E.g., when the slope changes from a steep to more shallow, this indicates that the flow rate of that gas supply flow is reduced, while an increase in the slope indicates that the flow rate of the gas supply flow has been increased. In the illustrated control strategy of FIG. 12, the supply pressure changes, e.g., the changes in the slope of the supply pressure, and hence the changes in flow rate of the gas supply flows are linear. However, the changes in flow rate and hence in supply pressure may also be non-linear. E.g., optionally, the flow rate of a gas supply flow may, e.g., be reduced as the receiving vessel reaches a state of being fully filled with gas, e.g., reaches its maximum capacity or a determined capacity. The flow control may be varied according to various mathematical functions, including different step functions, exponential functions etc. to mention a few non-limiting examples.

FIG. 13 illustrates a representation of a flow control strategy comprising a swing in strategy performed during a swing in period SW, according to an embodiment of the invention. The illustrated flow control strategy is based on state of charge and supply parameter thresholds PT-PT4. In this example, the supply parameter thresholds are state of charge thresholds. The state of charge is measured in percent. The first state of charge threshold is 20 percent, while the second state of charge threshold is 10 percent, the third state of charge threshold is 40 percent, and the fourth state of charge threshold is 80 percent. This flow control strategy is similar to the control strategy illustrated in FIG. 12, with the exception that the flow control is based on state of charge instead of being based on supply pressure. The state of charge may be determined based on pressure and temperature readings.

Notice that although this has not been described in detail, regulation based on flow measurements may also be implemented according to non-illustrated embodiments of the invention.

### LIST OF REFERENCE SIGNS

CA Compression arrangement
CO Common outlet
CS1-CS2 Compression stage
CTR Controller
GSV1-GSV3 Mobile gas supply vessel
HRS Hydrogen refueling system
IC1-IC2 Interconnecting conduit
IV1-IV2 Interconnecting valve
MGS Mobile gas supply
PT First supply parameter threshold
PT2 Second supply parameter threshold
SCA Supply conduit arrangement
SC1-SC2 Supply conduit
SCT State of charge threshold
SOC State of charge (SOC)
SOP Standard operation strategy
SP Supply pressure
SPT First supply pressure threshold
SPT2 Second supply pressure threshold
SPT3 Third supply pressure threshold
SV1-SV2 Supply valve
SW Swing in period
T1-T3, t Time

1. A hydrogen refueling system comprising:
a mobile gas supply comprising two or more mobile gas supply vessels;
a hydrogen refueling station comprising:
a common outlet fluidly connectable to a receiving vessel;
a compression arrangement including two or more compression stages each having an inlet and an outlet; and wherein said two or more compression stages are fluidly connected to said common outlet, and wherein at least one compression stage of said two or more compression stages is configured to establish an outlet pressure substantially at least equal to an inlet pressure of a second compression stage of said two or more compression stages;
a supply conduit arrangement comprising two or more supply conduits each comprising a supply valve and each having an upstream end and a downstream end, and wherein each said upstream end is separately fluidly connected to a respective mobile gas supply vessel of said two or more mobile gas supply vessels, and wherein each said downstream end is separately fluidly connected to a respective compression stage of said two or more compression stages;
one or more controllers configured to control said two or more compression stages and said supply valves to establish a gas supply flow from said mobile gas supply to said receiving vessel via each respective supply conduits of said two or more supply conduits, said compression arrangement and said common outlet, when said receiving vessel is fluidly connected to said common outlet.

2.-9. (canceled)

10. A hydrogen refueling system according to claim 1, wherein said control said gas supply flow in each supply conduit comprises establishing a first gas supply flow in a first supply conduit of said two or more supply conduits according to a first gas supply flow target and establishing a second gas supply flow in a second gas supply conduit of said two or more supply conduits according to a second gas supply flow target; and
wherein said first gas supply flow target and said second gas supply flow target is different.

11.-12. (canceled)

13. A hydrogen refueling system according to claim 1, wherein said control said gas supply flow comprises establishing a first flow reduction in said gas supply flow in a supply conduit of said two or more supply conduits when a first supply parameter of one or more supply parameters associated with said supply conduit crosses a first supply parameter threshold, and wherein said first supply parameter threshold is a first supply pressure threshold and wherein said first supply parameter is a supply pressure, and wherein said first flow reduction is performed when said supply pressure crosses said first supply pressure threshold.

14.-15. (canceled)

16. A hydrogen refueling system according to claim 1, wherein each of said supply conduits of said two or more supply conduits comprises one or more supply parameter sensors configured to measure one or more supply parameters of said supply conduit.

17. A hydrogen refueling system according to claim 16, wherein said one or more supply parameter sensors comprises at least a pressure sensor configured to measure a supply pressure of said supply conduit.

18.-22. (canceled)

23. A hydrogen refueling system according to-claim 1, wherein a controller of said one or more controllers is configured to control said gas supply flow in each respective supply conduits of said two or more supply conduits by controlling a compression stage capacity of each compression stage of said two or more compression stages.

24.-34. (canceled)

35. A hydrogen refueling system according to claim 1, wherein a controller of said one or more controllers is configured to reduce a gas supply flow in a supply conduit of said two or more supply conduits when a supply temperature of said gas supply conduit crosses a first temperature threshold.

36.-41. (canceled)

42. A hydrogen refueling system according to claim 1, wherein a controller of said one or more controllers is configured to empty a mobile gas supply vessel with a lowest state of charge of said two or more gas supply vessels at a lower flow rate than a mobile gas supply vessel of said two or more gas supply vessels with a higher state of charge of said two or more gas supply vessels.

43. A hydrogen refueling system according to claim 1, wherein said two or more mobile gas supply vessels connected to said supply conduit arrangement have different pressures and/or different state of charge.

44.-46. (canceled)

47. A hydrogen refueling system according to claim 1, wherein each of said two or more supply conduits are fluidly connected to a gas distribution arrangement configured to enable a fluid connection between any mobile gas supply vessel of said two or more gas supply vessels and any compression stage of said two or more compression stages; and wherein said gas distribution arrangement comprises interconnecting conduit comprising valves, and wherein said interconnecting conduit are arranged to connect each said supply conduit of said two or more supply conduit with one another.

48. (canceled)

49. A hydrogen refueling system according to claim 1, wherein when a first supply parameter of one or more supply parameters associated with a supply conduit of said two or more supply conduits crosses a second supply parameter threshold, a controller of said one or more controllers is configured to control said gas distribution arrangement to discontinue a gas supply flow in said supply conduit from a mobile gas supply vessel of said two or more gas supply vessels, and to establish a gas supply flow from another mobile gas supply vessel of said two or more gas supply vessels.

50.-57. (canceled)

58. A hydrogen refueling system according to claim 1, wherein said two or more compression stages are serially connected.

59. (canceled)

60. A hydrogen refueling system according to claim 1, wherein a compression outlet of a first compression stage is connected to a supply conduit connected to an inlet of a following compression stage, and wherein a controller of said one or more controllers is configured to control an outlet pressure of said first compression stage to be substantially equal to a supply pressure of a gas supply flow in said supply conduit connected to an inlet of a following compression stage.

61.-67. (canceled)

68. A hydrogen refueling system according to claim 1, wherein an outlet of each of said compression stage of said two or more compression stages are directly fluidly connected to said common outlet.

69.-71. (canceled)

72. A method of filling a receiving vessel; wherein said method comprises:
providing a first mobile gas supply vessel of a mobile gas supply;
fluidly connecting said first mobile gas supply vessel to a first supply conduit fluidly connected to a receiving vessel via a first compression stage and a common outlet;
providing a second mobile gas supply vessel of a mobile gas supply;
fluidly connecting said second mobile gas supply vessel to a second supply conduit fluidly connected to said receiving vessel via a second compression stage and said common outlet;
establishing a gas supply flow from said mobile gas supply to said receiving vessel, wherein said gas supply flow comprises one or more gas supply flows, including at least a first gas supply flow and a second gas supply flow, and wherein said first gas supply flow from said first mobile gas supply vessel to said receiving vessel via said first gas supply conduit, said first compression stage and said common outlet and wherein said second gas supply flow from said second mobile gas supply vessel to said receiving vessel via said second gas supply conduit, said second compression stage and said common outlet;
controlling a flow rate of said first gas supply flow in said first supply conduit and a flow rate of said second gas supply flow in said second supply conduit to be different; and
wherein said first compression stage is configured to establish an outlet pressure substantially at least equal to an inlet pressure of said second compression stage.

73.-75. (canceled)

76. The method according to claim 72, wherein said first mobile gas supply vessel and said second mobile gas supply vessel have different pressures.

77.-80. (canceled)

81. The method according to claim 72, wherein said method comprises a step of reducing a flow rate of said first gas supply flow of said first supply conduit by a first flow reduction when a first supply parameter associated with said first supply conduit of said one or more supply parameters crosses a first supply parameter threshold and/or reducing a flow rate of said second gas supply flow of said first supply conduit with a first flow reduction when a first supply parameter associated with said second supply conduit of said one or more supply parameters exceeds a first supply parameter threshold; and wherein said a first supply parameter of said one or more supply parameters includes one or more of the list comprising: supply pressure, supply temperature, state of charge of one or more of said two or more mobile gas supply vessels, gas supply flow.

82. (canceled)

83. (canceled)

84. The method according to claim 72, wherein said method comprises a step of increasing a flow rate in a supply conduit of said first supply conduit and said second supply conduit when reducing a flow rate in another supply conduit of said first supply conduit and said second supply conduit.

85. (canceled)

86. The method according to claim 72, wherein said method comprises a step of swapping a third mobile gas supply vessel with a mobile gas supply vessel to be swapped of said first and said second mobile gas supply vessels, wherein said mobile gas supply vessel to be swapped is associated with a first supply parameter crossing a second supply parameter threshold; and wherein said step of swapping a third mobile gas supply vessel comprises:
fluidly connecting said third mobile gas supply vessel to a third supply conduit fluidly connectable to any of said first compression stage and said second compression stage;
fluidly disconnecting a supply conduit from a compression stage of said first compression stage and said second compression stage, wherein said supply conduit is connecting said mobile gas supply vessel to be swapped with said compression stage;
fluidly connecting said third supply conduit to an unoccupied compression stage of said first and said second compression stage to establish a gas supply flow from said third mobile gas supply vessel to said receiving vessel via said third gas supply conduit, said unoccupied compression stage and said common outlet.

87. (canceled)

88. The method according to claim 86, wherein said second supply parameter threshold is includes one or more of the lists comprising a second supply pressure threshold, a second state of charge threshold, a second supply temperature threshold, a second gas supply flow threshold.

89.-100. (canceled)
